(19) United States
(12) Patent Application Publication
(10) Pub. No.: US 2016/0237720 A1
(43) Pub. Date: Aug. 18, 2016

(54) QUICK CONNECTION AND/OR FIXING SYSTEM FOR DOOR LEAVES, FLAPS OR SIMILAR ELEMENTS AND DOOR LEAF PROVIDED WITH SAID SYSTEM

(71) Applicant: MGT INDUSTRIES S.R.L., Schio (VI) (IT)

(72) Inventor: Giancarlo BRUN, Thiene (VI) (IT)

(73) Assignee: MGT INDUSTRIES S.R.L., Schio (VI), OT (IT)

(21) Appl. No.: 15/025,626

(22) PCT Filed: Sep. 23, 2014
(86) PCT No.: PCT/IB2014/064770

§ 371 Date: Mar. 29, 2016

(30) Foreign Application Priority Data
Sep. 30, 2013 (IT) VI2013A000239

(51) Int. Cl. E05B 63/24; E05B 65/08; E05B 15/02

(52) U.S. Cl. CPC E05B 63/24; E05B 15/0205; E05B 65/08

(57) ABSTRACT

The invention is a quick connection and/or fixing system suited to mutually connect and disconnect a door/window panel (200) to/from a portion of a wall (100); the panel (200) is suited to close an opening (A) giving access to a room at least partially defined by the wall (100), the system comprising a first and a second component (10, 20) suited to be rigidly fixed respectively to the wall portion (100) and to the panel (200), the first and the second component (10, 20) being furthermore suited to be mutually connected and disconnected so as to alternatively allow the mutual connection and disconnection of the panel (200) and the wall portion (100). The second component (20) is suited to accommodate an end portion (12) of the first component (10), in such a way as to allow its translation inside it, the second component (20) also comprising counteracting means suited to counteract the translation of the end portion (12) of the first component (10) towards the outside of the second component (20), the system also comprising at least one rotatable element (24) housed inside the second component (20) and suited to be set rotating according to a first direction of rotation by the translation of the end portion (12) of the first component (10) towards the inside of the second component (20), and suited to be set rotating in a second direction of rotation contrary to the first direction of rotation by the translation of the end portion (12) of the first component (10) towards the outside of the second component (20), the counteracting means being suited to counteract the rotation of the rotatable element (24) in the second direction of rotation, the second component (20) comprising releasing means (27) suited to be translated and to come into contact, during their motion according to a first pre-determined direction, with the rotatable element (24), in such a way as to move the rotatable element (24) so as to cause a decrease in the counteracting force between the rotatable element (24), the end portion (12) and the counteracting means, and the releasing means (27) comprise at least one handle suited to be operated by a user. The invention furthermore concerns a quick connection and/or fixing system, a door/window panel (200) and a component for a quick connection and/or fixing system.

### TECHNICAL FIELD OF THE INVENTION

The present invention concerns the field of quick connection and/or fixing systems suited to alternatively allow the mutual fastening and separation of two elements.

In particular, the present invention concerns the technical field of quick connection and/or fixing systems suited to be used as a lock in the closing elements of rooms, such as the panels of doors and/or windows (for houses, cars, motor homes and vehicles in general) and/or flaps in general, such as the panels of house furniture or other types of furniture, safe box doors, etc.

The present invention more particularly concerns the production of quick connection and/or fixing systems for doors/windows.

### DESCRIPTION OF THE STATE OF THE ART

Connection and/or coupling systems by means of which two components are fixed to each other are known in the art.

Concerning, furthermore, the quick connection and/or fixing systems suited to be used as a lock in the closing elements of rooms, such as the panels of doors and/or windows (for houses, cars, motor homes and vehicles in general) and/or flaps in general, such as the panels of house furniture or other types of furniture, safe box doors, etc., different and multiple solutions have been proposed in the recent past.

In the particular sector of building construction, doors, windows or French windows are used.

The door/window is typically constituted by a fixed frame and by one or more elements that can be moved with respect to the fixed frame, also called panels or leaves. The panel is then associated with a quick connection and/or fixing system or lock.

Doors of known type comprise a fixed frame associated with panels comprising panels for sliding doors, preferably hide-away doors, folding doors or sliding-folding doors, or single doors, wherein if necessary said frame can be combined with said sliding panels.

However, said lock solutions typically provided with a suitable handle that can be grasped by the user very often have been proposed in order to meet different needs and privilege the need for functionality and reliability in some cases, aesthetic or size requirements in other cases, or the need for ease of assembly and installation in other cases.

Therefore, none of the known solutions really meets all the needs just described above.

For example, the locks with handles of the classical type (rotary, with rack or similar) usually offer suitable guarantees in terms of functionality (which make them the favorite choice for use on doors and/or windows for houses in general) but are often characterized by considerable overall dimensions.

Furthermore, the known solutions sometimes are insufficient from the point of view of reliability and functionality.

The solutions for locks of the known type, furthermore, have a rather complex construction structure. Said solutions for locks, in fact, comprise on one side an area where the actual handle intended to be grasped by the user is applied and another part associated with the handle and comprising a mechanism (spring latch) typically provided with a projecting element (bolt). Said projecting element is suited to be accommodated in a special seat obtained in the fixed frame on which the panel provided with said lock is mounted.

To open the door/window, therefore, the user acts on the handle by rotating and/or translating the handle itself that in turn interacts with the mechanism for releasing the projecting element from the seat in the frame.

The mechanism (spring latch), furthermore, in many cases is provided with safety locking systems, for example a key lock, which allow the door/window to be opened only once the lock has been released, for example by means of the same key.

The operations for closing and/or opening the door/window provided with the locks of known type sometimes are particularly complex.

Due to their particularly complex structure, furthermore, as already explained, said known solutions sometimes are insufficient from the point of view of reliability and functionality.

Further examples of quick connection and/or fixing systems according to the prior art are known from each of documents U.S. Pat. No. 1,733,108, US 2010/320778 and DE 812 672.

It is thus one object of the present invention to overcome the drawbacks mentioned above and found in the known solutions proposed in the art.

In particular, the aims and objects of the present invention can be summed up as follows.

It is a first object of the invention to propose a quick connection and/or fixing system that, if used as a handle, provides suitable guarantees in terms of reliability (eliminating or drastically reducing the risk of accidental opening of the door or window or door of a piece of furniture), in terms of functionality (allowing the door or window or door of a piece of furniture to be opened with simple and immediate operations), in terms of ease of construction (comprising a limited number of component parts that are simple and easy to construct), as well as in terms of ease of assembly and/or application to the corresponding panel, and that has limited overall dimensions.

In greater detail, a further object of the present invention is to propose a quick connection and/or fixing system that, if used for mutually fixing two rigid elements, provides suitable guarantees against the accidental uncoupling of the parts mutually fixed through said system, said system being furthermore easy to assemble, suited to be carried out by means of operations that are simple and as quick as possible, as well as suited to be applied in a simple and immediate manner and in a reduced time to the parts to be mutually fixed and/or connected, and also wherein said system is not anti-aesthetic and has reduced overall dimensions.

In greater detail, a further object of the present invention is to propose a quick connection and/or fixing system that provides suitable guarantees against the accidental uncoupling of the parts mutually fixed through said system, said system being furthermore easy to release with simple operations.

### SUMMARY OF THE PRESENT INVENTION

The present invention is based on the general concept according to which the drawbacks or inconveniences that are typical of the solutions known in the art (in particular of the systems suited to be used as locks) can be overcome or at least minimised by providing a quick connection and/or fixing system comprising a first and a second component suited to be alternatively connected to and disconnected from each other, as well as suited to be fixed respectively to a wall portion and to a door/window panel (for example in a sliding door or a single door), in which the mutual connection of said two components takes place through the translation of a portion of said first component within said second component, while disconnection takes place through the translation of said portion of said first component in a direction substantially contrary to the coupling direction. In this way, the functionality of the device will be considerably simplified, as the user will not need to perform special operations but to close the door/window and thus connect the two components of the system he/she will just need to push the door/window in the closing direction while to disconnect the two components he/she will just need to pull a handle in the opening direction, substantially contrary to the closing direction. Furthermore, in this way it will be possible to develop a system characterized by a reduced number of component parts, each one of which is simple to construct and therefore to assemble and can be produced in a short time and at reduced costs. Furthermore, the overall dimensions of the system will be reduced, with evident advantages, even aesthetic.

A further consideration on which the present invention is based relates to the fact that further advantages can be obtained by providing the second component of the system with means suited to counteract the translation of the portion of the first component in the direction of disengagement, said counteracting means being activated by the translation of said portion of said first component. In this way, in fact, the system will be activated automatically against the accidental disengagement of the two components.

Further advantages will furthermore be obtained by providing counteracting means that are such that the force they exert against the translation of the end portion of the first component in the direction of disengagement increases during the translation of said end portion until causing said end portion to be locked inside said second component.

Furthermore, additional advantages will be obtained by providing the second component with means suited to deactivate said counteracting means in such a way as to obtain the mutual disconnection of said first and said second component whenever and only when the need arises.

Considerable advantages will finally be obtained when said deactivation means are made in such a way as to deactivate the counteracting means through the translation of said deactivation means in the same opening direction of the element to which the second component of the system will be applied, for example in the same direction as the opening direction of the panel. In this way, in fact, the intervention of the user to deactivate the counteracting means will allow the practically simultaneous opening of the drawer.

Advantageously, said deactivation means comprise at least one handle, more preferably two handles positioned on the opposite sides of the door/window panel, accessible by the user to deactivate the counteracting means.

According to a first aspect of the present invention, the subject of the same is therefore a quick connection and/or fixing system suited to mutually connect and disconnect a door/window panel to/from a wall portion, said panel being suited to close an access opening leading into a space at least partially defined by said wall, said system comprising a first and a second component suited to be rigidly fixed respectively to said wall portion and to said panel, said first and said second component being also suited to be connected and disconnected to/from each other in such a way as to alternatively allow the mutual connection and disconnection of said panel and said wall portion, wherein said second component is suited to house an end portion of said first component in such a way as to allow said end portion to translate inside it, said second component also comprising counteracting means suited to counteract the translation of said end portion of said first component towards the outside of said second component, said system furthermore comprising at least one rotatable element housed inside said second component and suited to be set rotating in a first direction of rotation by the translation of the end portion of the first component towards the inside of the second component, and suited to be set rotating in a second direction of rotation contrary to the first direction of rotation by the translation of the end portion of the first component towards the outside of the second component, said counteracting means being suited to counteract the rotation of said at least one rotatable element in said second direction of rotation, said second component comprising translatable releasing means suited to come into contact with said at least one rotatable element during their motion in a first predetermined direction, in such a way as to move said at least one rotatable element so as to decrease the counteracting force between said at least one rotatable element, said end portion and said counteracting means, and wherein said releasing means comprise at least one handle suited to be operated by a user. In a preferred embodiment of the invention, said translatable releasing means are suited to come into contact with said at least one rotatable element during their motion in a first predetermined direction, in such a way as to move said at least one rotatable element towards the inside of said second component and therefore in such a way as to decrease the counteracting force between said at least one rotatable element, said end portion and said counteracting means.

In a preferred embodiment of the invention, said at least one handle is positioned on at least one side of the second component so that it can be operated by the user from at least one side of the panel when the second component is fixed to the panel.

In a preferred embodiment of the invention, the releasing means comprise two handles, a first one of said handles being positioned on a first side of the second component and the other handle being positioned on the opposite side with respect to the first side of the second component, so that they can be operated by the user from the respective opposite sides of the panel when the second component is fixed to the panel.

In a preferred embodiment of the invention, said at least one handle can be operated along a direction that is substantially parallel to the first predetermined direction.

Preferably, said at least one handle can be operated by means of a thrusting action along a longitudinal direction towards the second component in such a way as to produce a thrusting action along a longitudinal direction towards the panel when the second component is fixed to the panel.

In another preferred embodiment of the invention, said at least one handle can be operated by means of a pulling action along a longitudinal direction away from the second component in such a way as to produce a pulling action along a longitudinal direction away from the panel when the second component is fixed to the panel.

In a further preferred embodiment of the invention, said at least one handle can be operated by means of a rotation operation performed by the user.

Preferably, the second component comprises second thrusting means that exert a thrusting action against the releasing means in a second direction contrary to the first direction of motion of the releasing means.

Advantageously, the second thrusting means comprise elastic means and/or magnetic means and/or electromagnetic means.

In a preferred embodiment of the invention, the second component comprises safety locking means suited to inhibit the movement of said at least one handle. In a preferred embodiment of the invention, the releasing means comprise two handles and said second component comprises safety locking means suited to inhibit the movement of at least one of said two handles.

Preferably, the safety locking means can be operated from a first side of the second component and are suited to inhibit the movement of the handle positioned on the opposite side with respect to the first side of the second component.

In another preferred embodiment of the invention, the safety locking means are suited to inhibit the movement of both handles.

Preferably, the safety locking means can be operated from both a first side of the second component and the opposite side with respect to the first side of the second component.

The safety locking means conveniently comprise a locking element that can be operated manually by the user.

In a preferred embodiment of the invention, the locking element comprises a lever suited to be rotated around a rotation axis through one of its parts so as to be arranged in at least one operative locking position intended to lock said at least one handle and in at least one inoperative position that does not interfere with said at least one handle.

In another preferred embodiment of the invention, the safety locking means comprise a locking element that is suited to be operated by the user by means of a key.

Preferably, the locking element comprises a cylindrical portion that can be rotated through the rotation of said key, said cylindrical portion comprising a recessed seat on its external cylindrical surface, said cylindrical portion being suited to be arranged in at least one operative angular position intended to lock said at least one handle, in which said external cylindrical surface is in contact with a portion of said at least one handle, and in at least one inoperative position that does not interfere with said at least one handle, in which said recessed seat receives said portion of said at least one handle while said handle is being moved.

In a preferred embodiment of the invention, the system comprises emergency releasing means suited to be operated in order to release said safety locking means and restore the possibility to move said at least one handle.

Preferably, the emergency releasing means comprise at least one opening created in the casing of the second component in such a way as to allow an operator to act on the safety locking means using a suitable tool in order to release them. Preferably, said at least one handle comprises a lever or a knob.

In a preferred embodiment of the invention, the second component comprises a rigid portion that defines, together with the end portion of the first component, an inner space, wherein at least one rotatable element is housed in said space, and wherein the end portion of the first component, said rigid portion and said at least one rotatable element are mutually positioned and shaped in such a way that said counteracting force is generated thanks to the mutual action of said rigid portion and of said end portion on the at least one rotatable element.

Preferably, the end portion, the rigid portion and said at least one rotatable element are mutually positioned and shaped in such a way that said counteracting force contrary to the translation of the end portion towards the outside of the second component and to the rotation of the at least one rotatable element in the second direction of rotation increases during the translation of the end portion towards the outside of the second component, while it decreases during the translation of the end portion towards the inside of the second component.

Preferably, the end portion, said rigid portion and said at least one rotatable element are mutually positioned and shaped in such a way that said counteracting force contrary to the translation of the end portion towards the outside of the second component and to the rotation of said at least one rotatable element in the second direction of rotation increases during the translation of the end portion towards the outside of the second component until preventing any further translation of the end portion towards the outside of the second component and any further rotation of said at least one rotatable element in the second direction of rotation, and thus until causing the end portion and said at least one rotatable element to be mutually locked in a determined mutual position.

In a preferred embodiment of the invention, the rigid portion of the second component is oriented with respect to the first component and/or shaped in such a way that said at least one rotatable element is pushed towards the end portion of the first component during the rotation of said at least one rotatable element in the first direction of rotation.

Preferably, the mutual distance between the contact point of said at least one rotatable element with the rigid portion and the end portion of the second component increases in the direction of translation of the end portion towards the inside of the second component, while it decreases in the direction of translation of the end portion towards the outside of the second component.

Preferably, the rotatable element is in contact with both the end portion and the rigid portion, so that the translation of the end portion towards the inside of the second component generates an at least partial translation of said at least one rotatable element towards the inside of the second component, while a translation of the end portion towards the outside of the second component generates an at least partial translation of said at least one rotatable element towards the outside of the second component.

In a preferred embodiment of the invention, first thrusting means are housed inside the second component and exert a thrusting action on the at least one rotatable element towards the inner space defined by the end portion and the rigid portion.

The first thrusting means properly comprise elastic means.

The first thrusting means comprise magnetic and/or electromagnetic means, alternatively to or in combination with each other.

According to another aspect of the present invention, the subject of the same is a quick connection and/or fixing system suited to mutually connect and disconnect a door/window panel to/from a wall portion, said panel being suited to close an access opening leading into a space at least partially defined by said wall, said system comprising a first and a second component that are suited to be rigidly fixed respectively to said wall portion and to said panel, said first and said second component being also suited to be mutually connected and disconnected in such a way as to alternatively allow the mutual connection and disconnection of said panel and said wall portion, wherein said second component is suited to house an end portion of said first component in such a way as to allow said end portion to translate inside it, said second component also comprising counteracting means suited to counteract the translation of said end portion of said first component towards the outside of said second component, said system furthermore comprising two rotatable elements housed inside said second component and suited to be set rotating in a first direction of rotation by the translation of the end portion of the first component towards the inside of the second component, and suited to be set rotating in a second direction of rotation contrary to the first direction of rotation by the translation of the end portion of the first component towards the outside of the second component, said counteracting means being suited to counteract the rotation of said two rotatable elements in said second direction of rotation, said second component comprising translatable releasing means suited to come into contact with said two rotatable elements during their motion in a first predetermined direction, in such a way as to move said two rotatable elements so as to decrease the counteracting force between said two rotatable elements, said end portion and said counteracting means.

Preferably, the two rotatable elements are housed inside said second component in a position in which they face each other.

Preferably, the releasing means comprise at least one handle suited to be operated by a user.

According to another aspect of the present invention, the subject of the same is a door/window panel comprising a component of a quick connection and/or fixing system suited to mutually connect and disconnect said panel to/from a wall portion, wherein said component is constituted by the second component of the connection and/or fixing system as described above.

Preferably, the panel according to the present invention constitutes a door/window panel.

In a preferred embodiment of the invention, the panel according to the present invention constitutes the panel of a sliding door/window.

In another preferred embodiment of the invention, the panel according to the present invention constitutes the panel of a single door or window.

According to a further aspect of the present invention, the subject of the same is a component for a quick connection and/or fixing system suited to mutually connect and disconnect a door/window panel to/from a wall portion, said component being suited to be rigidly fixed to said wall portion and being suited to be mutually connected and disconnected to/from a second component associated with said panel, in such a way as to alternatively allow the mutual connection and disconnection of said panel and said wall portion, wherein said component comprises an end portion suited to be housed in said second component, and wherein the component comprises protection means suited to protect said end portion.

In a preferred embodiment of the invention, the protection means comprise a covering element for the end portion, the covering element being suited to assume a first covering position in which it covers the end portion when the component is disconnected from the second component and to assume a second position in which said end portion is not covered when the component is connected to the second component.

Preferably, the covering element is an element that can be retracted with respect to the wall portion.

In another preferred embodiment of the invention, the protection means comprise a kinematic mechanism suited to arrange the end portion in a first position in which it does not project from the wall portion when the component is disconnected from the second component and in a second position in which it projects from the wall portion when the component is connected to the second component.

Preferably, the protection means comprise magnetic attraction means suited to arrange the end portion in a first position in which it does not project from the to wall portion when the component is disconnected from the second component and in a second position in which it projects from the wall portion when the component is connected to the second component.

### BRIEF DESCRIPTION OF THE FIGURES

The present invention is illustrated here below through the description of some embodiments shown in the attached drawings. It should however be noted that the present invention is not limited to the embodiments shown in the drawings; on the contrary, the field of application and the scope of the present invention include all those variants or modifications of the embodiments illustrated and described herein that will be clear, obvious and immediate to the expert in the art. In particular, in the attached drawings:

FIG. 1 shows the connection system according to a first embodiment of the present invention associated with a sliding door;

FIG. 2 shows an axonometric view of the connection system of FIG. 1 isolated from the rest;

FIG. 3 shows a side plan view of the system of FIG. 2;

FIGS. 4A, 4B and 4C show corresponding plan views of the open system of FIG. 3 with the first and the second component of said system in different operating positions, respectively in the position in which they are disengaged, in the position in which they are engaged and in the position in which they are released and ready for disengagement;

FIGS. 5A, 5B and 5C show enlarged details of the corresponding FIGS. 4A, 4B and 4C;

FIG. 6 shows a variant embodiment of the system illustrated in FIG. 2;

FIG. 7 shows the system of FIG. 6 in the open configuration, in which the inner components are visible;

Figures from 8 to 10 show corresponding views of the system of FIG. 7 according to different points of view and in different operating positions, respectively with inoperative locking system and levers not operated, with one lever operated and with operative locking system;

FIGS. 10A and 10B show two details of the system of FIG. 7 isolated from the rest;

FIG. 10C shows the system of FIG. 7 with operative locking system and levers not operated;

FIG. 10D shows the system of FIG. 10C with the locking system made inoperative through the operation of one lever;

FIG. 11 shows an exploded view of the system of FIG. 6;

FIG. 12 shows a first side plan view of a variant embodiment of the system of FIG. 6;

FIG. 13 shows the side plan view of the opposite side of FIG. 12;

FIG. 14 shows the system of FIG. 13 in the open configuration, in which the inner components are visible;

FIG. 15 shows an axonometric view of the system of FIG. 14 in a first operating position;

FIG. 15A shows an enlarged detail of FIG. 15;

FIG. 16 shows an axonometric view of the system of FIG. 14 in a second operating position;

FIG. 16A shows an enlarged detail of FIG. 16;

FIG. 17 shows a variant embodiment of the system of FIG. 2;

FIG. 18 shows a side plan view of the system of FIG. 17;

FIG. 19 shows the side plan view of the opposite side of FIG. 18;

FIG. 20 shows the system of FIG. 18 in the open configuration, in which the inner components are visible;

FIG. 21 shows an axonometric view of the system of FIG. 20;

FIG. 22 shows the system of FIG. 20 in a particular operating condition;

FIG. 23 shows an exploded view of the system of FIG. 17;

FIG. 24 shows the connection system according to another embodiment of the invention associated with a sliding door;

FIG. 25 shows an axonometric view of the connection system of FIG. 24 isolated from the rest, in which some elements have been removed so that the inner elements are visible;

FIG. 26 shows a side plan view of the system of FIG. 24 isolated from the rest;

Figures from 27 to 29 show the system of FIG. 26 along section plane I-I in different operating positions, respectively in the position in which they are disengaged, in the position in which they are engaged and in the position in which they are released and ready for disengagement;

FIG. 30 shows the system of FIG. 25 in a first operating condition, corresponding to the operating condition of engagement shown in FIG. 28;

FIG. 31 shows the plan view of FIG. 30;

FIG. 32 shows the system of FIG. 25 in a second operating condition, corresponding to the operating condition of release shown in FIG. 29;

FIG. 33 shows the plan view of FIG. 30;

FIG. 34 shows the system of FIG. 25 in a further operating condition, corresponding to the safety locking of the system;

FIG. 35 shows the plan view of FIG. 34;

FIG. 36 shows an exploded view of the system of FIG. 24 isolated from the rest;

FIG. 36A shows some details of FIG. 36 according to another point of view;

FIG. 37 shows the connection system according to another embodiment of the invention associated with a single door;

FIG. 38 shows an axonometric view of the connection system of FIG. 37 isolated from the rest;

FIG. 39 shows the system of FIG. 38 from which some elements have been removed so that the inner elements are visible;

FIG. 40 shows an exploded view of the system shown in FIG. 38;

FIG. 40A shows a detail of FIG. 40 according to a different point of view;

FIG. 41 shows the system of FIG. 38 according to a different point of view and with an enlarged detail;

FIG. 42 shows a top view of FIG. 39 with the system in the operating condition of disengagement;

FIG. 43 shows a top view of FIG. 39 with the system in the operating condition of engagement;

FIG. 44 shows the system of FIG. 41 in the operating condition of release;

FIG. 45 shows the system of FIG. 44 according to a different point of view, from which some elements have been removed so that the inner elements are visible;

FIG. 46 shows the top view of FIG. 45 with the system in the operating condition of release;

FIG. 47 shows the connection system according to another embodiment of the invention associated with a single door;

FIG. 48 shows an axonometric view of the connection system of FIG. 47 isolated from the rest, from which some elements have been removed so that the inner elements are visible;

FIG. 49 shows a top view of FIG. 48 with the system in the operating condition of disengagement;

FIG. 50 shows a top view of FIG. 48 with the system in the operating condition of engagement;

FIG. 51 shows a top view of FIG. 48 with the system in the operating condition of release;

FIG. 52 shows the system of FIG. 47 from a different point of view, in the operating condition of release;

FIG. 53 shows the system of FIG. 52, in the operating condition of safety locking;

FIG. 54 shows a top view of the system of FIG. 47 isolated from the rest;

FIG. 55 shows a view along section plane II-II of FIG. 54 with the system in the position of engagement;

FIG. 56 shows a view along section plane II-II of FIG. 54 with the system in the position of release;

FIG. 57 shows a view along section plane II-II of FIG. 54 with the system in the position of safety locking;

FIG. 58 shows a view along section plane II-II of FIG. 54 with the system in the position of safety release;

FIG. 59 shows an exploded view of the system of FIG. 47 isolated from the rest;

FIG. 60 shows a detail of FIG. 59 according to a different point of view;

FIGS. 61A, 61B and 61C show a variant embodiment of the system of the invention in the positions corresponding to FIGS. 4A, 4B and 4C;

FIG. 62 shows an exploded axonometric view of a detail of the system shown in FIGS. 61A, 61B and 61C;

FIG. 63 shows a front plan view from the left of the system shown in FIGS. 61A, 61B and 61C;

FIG. 64 shows an exploded axonometric view of a preferred embodiment of a detail of the system according to the present invention;

FIG. 65 shows a plan and section view of the detail of FIG. 64 associated with a wall portion in a first operating position;

FIG. 66 shows a plan and section view of the detail of FIG. 64 associated with a wall portion in a second operating position;

Figures from 67 to 69 show different plan views of the detail of FIG. 64 in different operating positions in a system according to the present invention;

FIG. 70 shows an exploded axonometric view of a preferred embodiment of a detail of the system according to the present invention;

FIG. 71 shows a plan and section view of the detail of FIG. 70 associated with a wall portion in a first operating position;

FIG. 72 shows a plan and section view of the detail of FIG. 70 associated with a wall portion in a second operating position;

Figures from 73 to 75 show different plan views of the detail of FIG. 70 in different operating positions in a system according to the present invention;

FIG. 76 shows an exploded axonometric view of a preferred embodiment of a detail of the system according to the present invention;

FIG. 77 shows a plan and section view of the detail of FIG. 76 associated with a wall portion in a first operating position;

FIG. 78 shows a plan and section view of the detail of FIG. 76 associated with a wall portion in a second operating position;

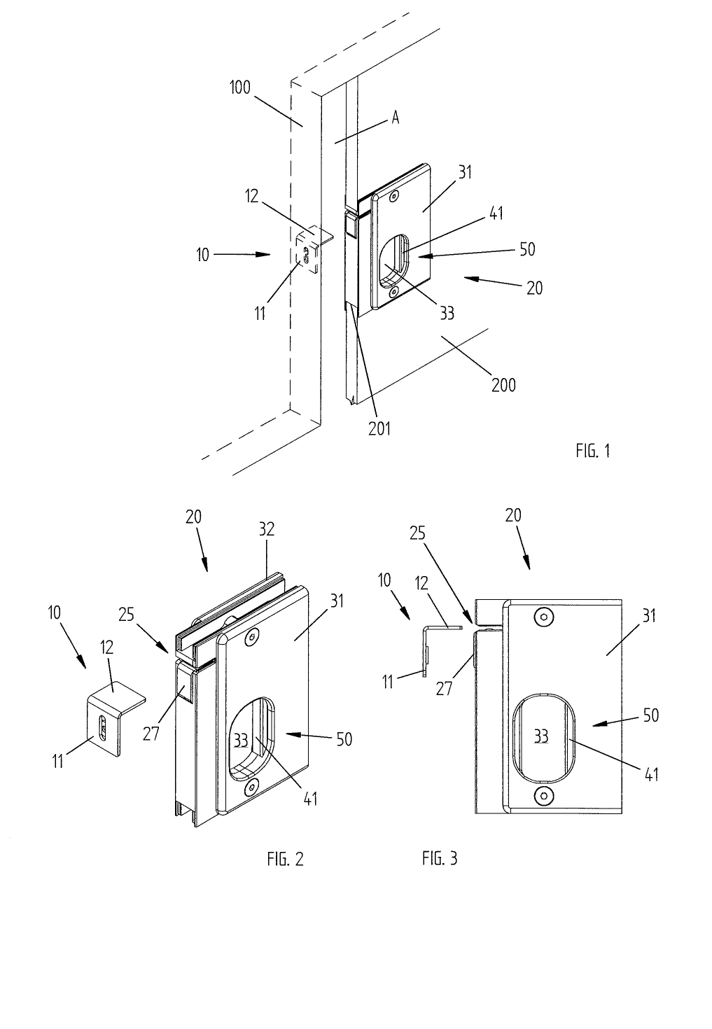

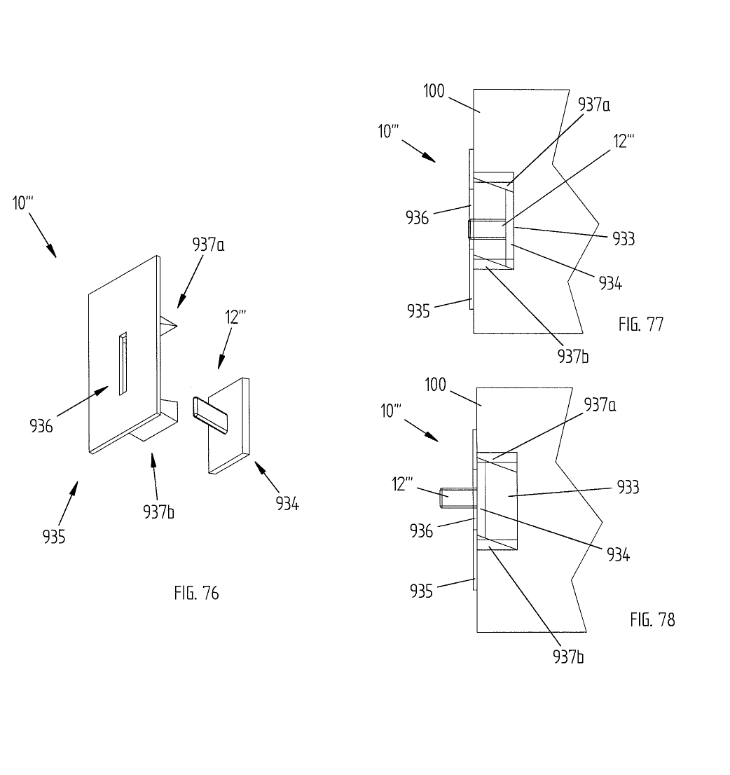

Figures from 79 to 81 show different plan views of the detail of FIG. 76 in different operating positions in a system according to the present invention.

### DETAILED DESCRIPTION OF SOME EMBODIMENTS OF THE PRESENT INVENTION

The present invention can be especially and conveniently applied in the field of production of quick connection and/or fixing system (locks) for doors and windows in general. It is for this reason, therefore, that the examples of application of the system according to the present invention described below concern the particular case of the locks of the type generally used for common doors and/or windows.

It should however be noted that the possible applications of the system according to the present invention are not limited to the particular case of locks for doors and windows. On the contrary, the present invention can be advantageously applied in all those cases in which it is necessary to fix two components to each other in a quick and reliable manner (avoiding any accidental disconnection), and in which a component is constituted by a closing element for an access opening leading into a space and the other component is associated with the opening itself. For example, in a safe box a component can be constituted by the safe box door and the other component is constituted by the frame supporting the door. The present invention can be usefully applied in the construction of drawers, door/window panels, flaps and doors in general.

The first embodiment of the present invention represented in Figures from 1 to 24 comprises a first component 10 and a second component 20 suited to interact with each other as is explained in greater detail below. The first component 10 is shaped as a small bar (for example in metal, plastic or another similar rigid material) and is suited to be rigidly fixed to a wall portion 100, for example a doorpost.

The second component 20 is carried out in the form of a unit suited to be rigidly fixed to a door/window panel 200, for example in the embodiment illustrated herein the sliding panel of a door or a window or a French window. The panel 200, as is known, makes it possible to close an access A defined by an opening in the wall 100. For this purpose, the second component 20 is housed in a suitable seat 201 in the panel 200. The second component 20 preferably comprises two external closing plates 31, 32 suited to make it easier to apply it to the panel 200 and to obtain the desired aesthetic aspect. The second component 20 preferably comprises also a through opening 33 that serves as a holding area for the fingers of a user who needs to move the panel 200 towards the closing and/or opening position. Furthermore, the through opening 33 allows access to an activating portion 41. As is better described below, acting on the activating portion 41 so as to push it towards the opening position of the panel 200, to the right in the various figures, will open the panel 200 especially starting from a closed and locked position. The activating portion 41 substantially works as a handle for the panel 200 in question.

In the embodiment illustrated herein, the opening 33 is advantageously a through opening and allows access to the same handle 41 from both sides of the panel 200. Such a solution could be used, for example, in the case of a panel 200 of a sliding door of a train.

In variant embodiments of the invention, however, the opening can be blind and not a through opening, in order to maintain the isolation between the two sides of the panel (as required, for example, in the case of a toilet door). In this case the opening is substantially provided with a diaphragm that separates the two sides of the panel.

The separation diaphragm can be part of the handle itself or belong to the structure of the second component.

In this variant embodiment, the same handle may in any case be suited to be operated from both sides of the panel or, alternatively, the handle may be suited to be operated from one side of the panel only, making it impossible to use the handle and therefore to open the door when it is closed for a user situated on the other side of the door.

The first component 10 comprises an end portion 11 through which the first component itself is fixed to the wall portion 100, as well as a second end portion 12 suited to be received and housed in a hollow seat 25 having a corresponding and matching shape and obtained in the second component 20. A space 26 is also obtained inside the second component 20, delimited on one side by a rigid portion 21 (for example a metal strap) inclined with respect to the end portion 12 of the first component 10. In variant embodiments of the invention said rigid portion can be made in a different way and if necessary it may be defined by an inclined surface created directly in the second component, in the latter case without providing any additional element as the metal strap illustrated herein.

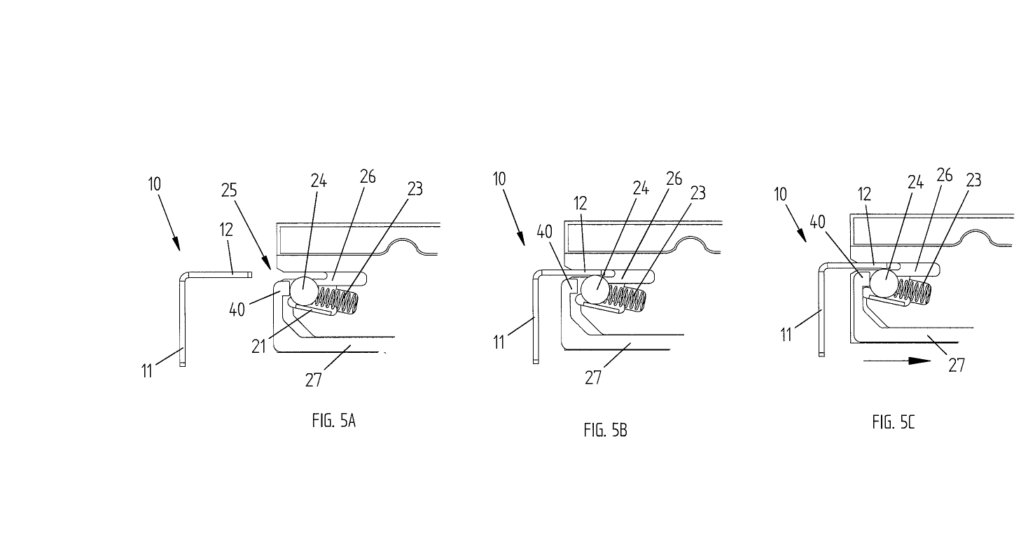

The end portion 12 is suited to translate within the seat 25 in such a way as to come into contact with the space 26 on the opposite side with respect to the inclined portion 21. For the sake of clarity, the direction of translation of the end portion 12 from left to right in FIGS. 5A, 5B and 5C here below will be defined also as the direction of translation towards the inside of the second component 20, while the direction of translation of the end 12 from right to left in FIGS. 5A, 5B and 5C will be defined also as the direction of translation towards the outside of the second component 20. The inclination of the portion 21 is such that the distance between it and the end 12 decreases proceeding along the direction of translation of the same end 12 towards the outside of the second component 20, while it increases in the opposite direction, that is, in the direction of translation towards the inside of the component 20. Furthermore, a helical spring 23 is housed inside the space 26. Always inside the space 26 there is a rotatable and translatable element 24, for example a ball, placed at the level of the free end of the helical spring 23 in such a way that the helical spring 23 exerts a thrusting force on said rotatable element 24 towards the terminal area of the space 26 in which the distance between the rigid portion 21 and the end 12 decreases.

In variant embodiments of the invention the rotatable and translatable element can be of a different type, like for example a small cylinder or rod iron.

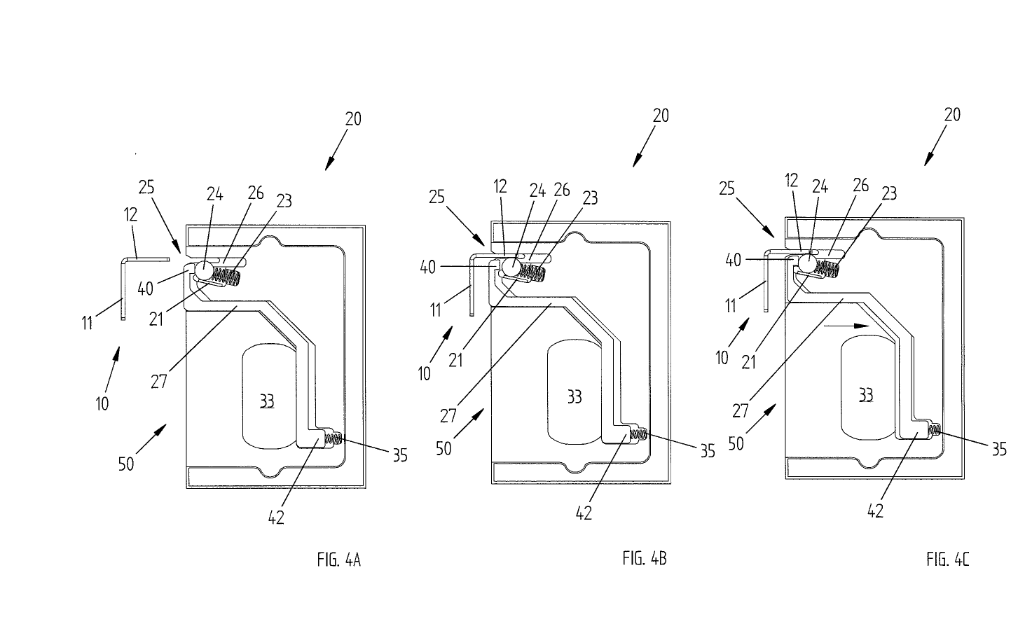

The second component 20 is advantageously associated with releasing means 50, described in detail here below, comprising a releasing element 27 suited to be translated inside the second component 20 in a direction substantially parallel to the direction of translation of the end portion 12 and therefore from left to right in FIGS. 5A, 5B and 5C (towards the inside of the component 20) and from right to left in FIGS. 5A, 5B and 5C (towards the outside of the component 20). In the preferred embodiment of the invention illustrated and described herein, the releasing element 27 preferably comprises a shaped lever. This shaped lever comprises a first portion 40 suited to be placed in contact with the rotatable element 24 and said centre portion 41, or handle, suited to be reached by a user. The releasing element 27 is especially suited to be translated towards the inside of the component 20 through the action of the user on the centre portion 41, as previously mentioned, and therefore through the pulling action of the user on the centre portion 41 from left to right in FIGS. 4C and 5C. The releasing element 27 is maintained in the inoperative position in the direction contrary to the pulling direction, and therefore from right to left in the figures, through the action of an elastic return spring 35 that preferably acts on a lower end 42 of the lever 27.

In variant embodiments of the invention, the thrusting return means may be made in a different manner, for example using suitable magnetic and/or electromagnetic means.

During its translation towards the inside of the second component 20, the releasing element 27 will abut the rotatable element 24 thus pushing it towards the inside of the component 20 against the action of the spring 23, and thus pushing it towards that portion of the inner space 26 in which the distance between the rigid portion 21 and the end 12 of the first component 10 increases.

The operation of the connection system according to the embodiment of the present invention illustrated in the Figures from 4A to 4C and from 5A to 5C can be summed up as follows. The mutual connection of the first component 10 and the second component 20 is obtained through the translation or mutual sliding movement of the first component 10 towards the second component 20, meaning the sliding movement of the panel 200 towards its closed position.

During said approaching movement, the end portion 12 of the first component 10 slides towards the inside of the second component 20. During the translation of the end 12 towards the inside of the component 20, the surface of the end 12 facing towards the portion 21 comes into contact with the outer surface of the rotatable element 24 that therefore will first be set rotating clockwise and then translating owing to the friction that is generated between the end 12 and the rotatable element 24, said rotatable element 24 being in contact also with the surface of the portion 21 facing towards the end 12 of the first component 10. During its clockwise rotation and its successive translation, the rotatable element 24 will thus move against the action of the spring (from left to right in FIGS. 4B and 5B) and thus towards that part or portion of the space 26 in which the distance between the rigid portion 21 and the end 12 of the first component 10 increases. The rotatable and translatable element 24 therefore will not hinder the translation of the end 12 towards the inside of the component 20, so that the end portion 12 can reach its final position inside the component 20, final position that is thus defined as the mutual locking position between the first component 10 and the second component 20, in such a way as to mutually lock the two elements 100 and 200 in a predefined position (that is, to lock the panel 200 to the doorpost 100).

The accidental disconnection of the first component 10 from the second component 20, and therefore for example the accidental opening of the panel 200, will be impossible, as in the locked condition illustrated in FIG. 4B any accidental translation of the end 12 towards the outside of the component 20 will be impossible. In fact, during the translation of the end portion 12 towards the outside of the component 20, the rotatable element 24 is set rotating counterclockwise, and if necessary it is also set translating (owing to the friction between the end 12 and the rotatable element 24 itself), and then moved towards that portion of the space 26 in which the distance between the rigid portion 21 and the end 12 decreases. The movement of the rotatable element 24 towards said portion of the space 26 (and thus substantially towards the outside of the component 20) thus leads to the engagement of the rotatable element 24 between the end 12 and the portion 21, so that at a certain moment neither a further counter-clockwise rotation of the rotatable element 24 nor a further translation of the end 12 towards the outside of the component 20 will be possible. In other words, at a certain point during its counter-clockwise rotation, and therefore at a certain point of the translation of the end 12 towards the outside, the rotatable element 24 will become engaged between the end 12 and the rigid portion 21 in such a way as to lock also the end 12. Therefore, a user who, for example, intends to open the panel 200 by acting directly on said panel 200 without acting on the centre portion 41 of the lever 27 will not be able to obtain the mutual release of the second component 20 from the first component 10 and therefore will not be able to open said panel 200. The mutual release of the two components 10 and 20, and therefore the opening of the panel 200, on the other hand, can be achieved by pulling the centre portion 41 of the lever 27 from left to right as shown in FIGS. 4C and 5C, and thus in such a way as to translate the releasing element 27 towards the inside of the component 20. In fact, during its translation towards the inside of the component 20, the releasing element 27, as previously mentioned, will push the rotatable and translatable element 24 towards the inside of the component 20 with its end 40, and therefore towards the portion of the space 26 in which the distance between the portion 21 and the end 12 increases. In this way, therefore, the opposing movement (friction) between the external surface of the rotatable and translatable element 24 and the surface of the end 12 facing towards the rigid portion 21 decreases, even to the point of being completely eliminated in the position in which the rotatable and translatable element 24 is no more in contact with the end 12. Therefore, in these conditions, a translation of the end 12 towards the outside of the component 20 will cause neither a counter-clockwise rotation of the rotatable element 24 nor a movement or shifting of the same towards the outside (towards that portion of the space 26 in which the distance between the end 12 and the portion 21 decreases), so that the end 12 will be free to translate until it moves completely out of the component 20, as shown in FIGS. 4C and 5C. It can thus be understood from the explanation provided above that a user can open the panel 200 by simply pulling the centre portion 41 of the lever 27 in the door opening direction, so that a single traction of the centre portion 41 of the lever 27 will allow first the mutual release of the two components 20 and 10 of the system and also the opening of the panel 200 itself. On the contrary, any attempt to open the panel 200 without acting on the centre portion 41 of the lever 27 will cause the mutual locking of the two components 20 and 10 of the system.

Figures from 6 to 11 show a variant embodiment of the system according to the present invention.

In said embodiment of the invention the operating principle is substantially equal to that described above with reference to the first embodiment, and therefore it will not be described in detail here below.

The rotatable and translatable element 24 and the first component 10 with the surface of the end 12 thus interact according to the principle described above. This embodiment differs from the already described first embodiment due to the different construction structure of the handle 127 and to the presence of safety locking means 151 of the handle 127 itself.

Identical elements and/or elements having the same characteristics as those described with reference to the first embodiment of the invention are indicated by the same reference numbers used for the first embodiment itself.

The handle 127, which belongs to the releasing means 150 of the system, preferably comprises two shaped levers 127a, 127b. Each lever 127a, 127b comprises a first portion 140a, 140b suited to be placed in contact with the rotatable element 24 and a centre portion 141a, 141b that can be reached by a user.

In this embodiment of the invention, the opening 133 is advantageously provided with a diaphragm element 135 and therefore is not a through opening.

Advantageously, the two shaped levers 127a, 127b are arranged on one side and on the other of the diaphragm 135 and thus on one side and on the other of the panel 200.

The handle 127 can therefore be operated from both sides of the panel 200 by acting independently on one of the two shaped levers 127a, 127b.

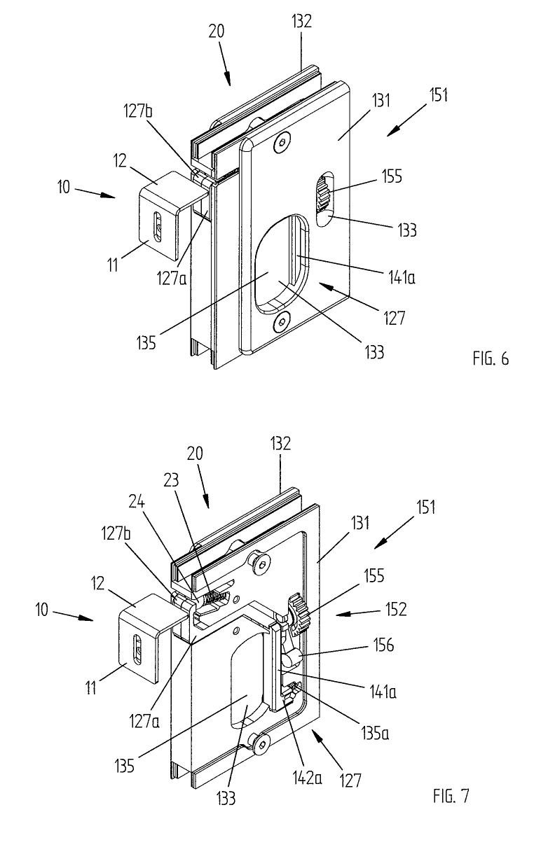

Each shaped lever 127a, 127b is suited to be translated towards the inside of the component 20 through an action exerted by the user on the corresponding centre portion 141a, 141b, as previously mentioned, and therefore through a traction operation from left to right performed by a user on the centre portion 141a, 141b as shown in FIGS. 6 and 7. Each shaped lever 127a, 127b is advantageously kept in the inoperative position in the direction contrary to the traction direction, and therefore from right to left in FIGS. 6 and 7, through the action of a corresponding elastic return spring 135a, 135b that preferably acts at a lower end 142a, 142b of the lever 127a, 127b.

According to this embodiment, the system that is the subject of the invention preferably comprises safety locking means 151 suited to lock the handle 127 itself.

More particularly, the safety locking means 151 illustrated and described herein can be operated manually by acting directly on a knurled pawl 155 projecting from one side of the system, more preferably projecting from a slit 133 made in one 131 of the two external closing plates 131, 132.

The safety locking means 151 are advantageously operated by a user that is situated on one side of the panel 200, for example inside a room, in order to lock and thus inhibit the action of one of the two levers 127a, 127b that is located on the other side of the panel 200, as is better described below.

The safety locking means 151, in fact, comprise a first locking element 152 suited to be moved by the user so that it can be arranged in at least one inoperative position without any effect on the two levers 127a, 127b and in an operative and locking position on one of the two levers 127b, as described above. Preferably, the movement between the operative position and the inoperative position of the first locking element 152 takes place through the rotation of the first locking element 152 itself by means of the rotation of the knurled pawl 155. In variant embodiments of the invention, the movement can be of a different type, for example it can be obtained through the translation or rotation-translation of a special locking element.

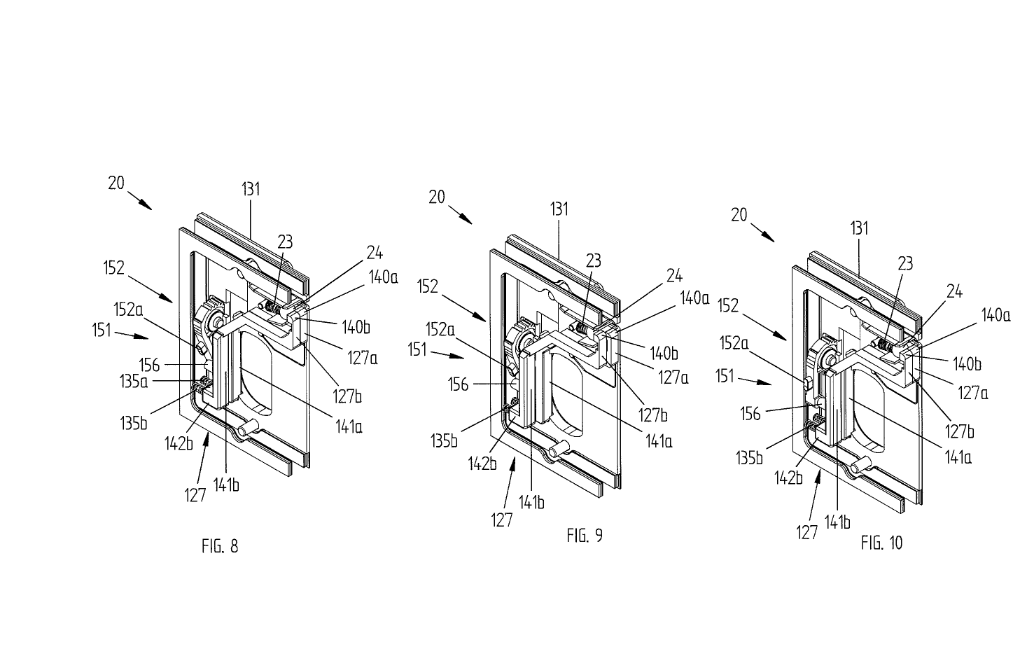

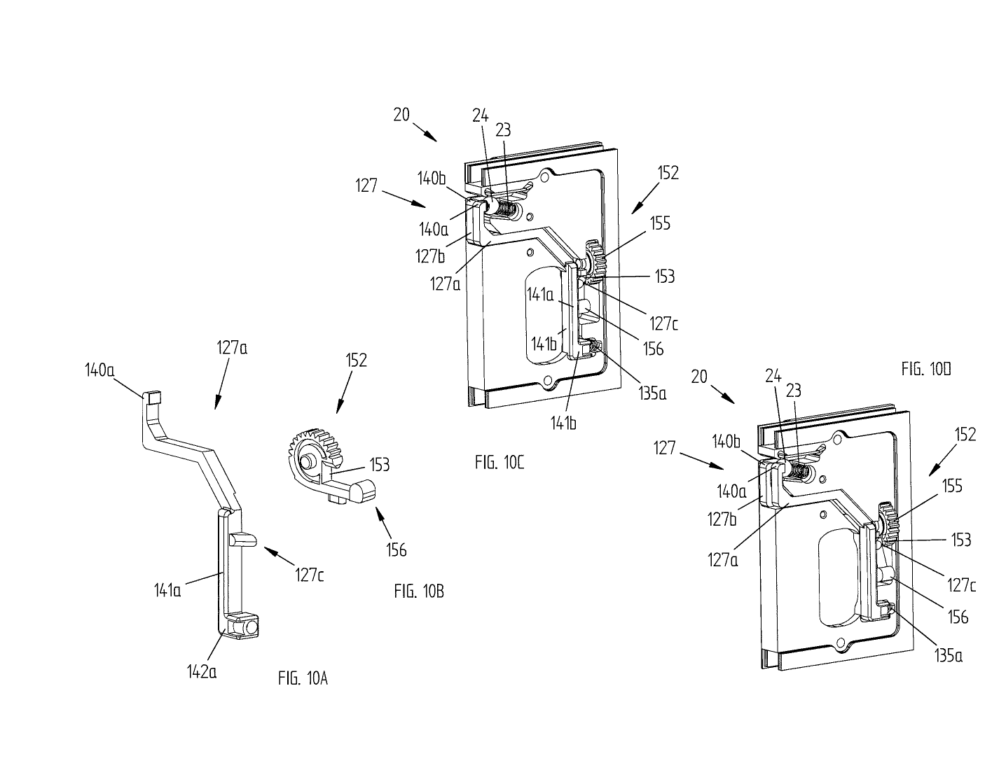

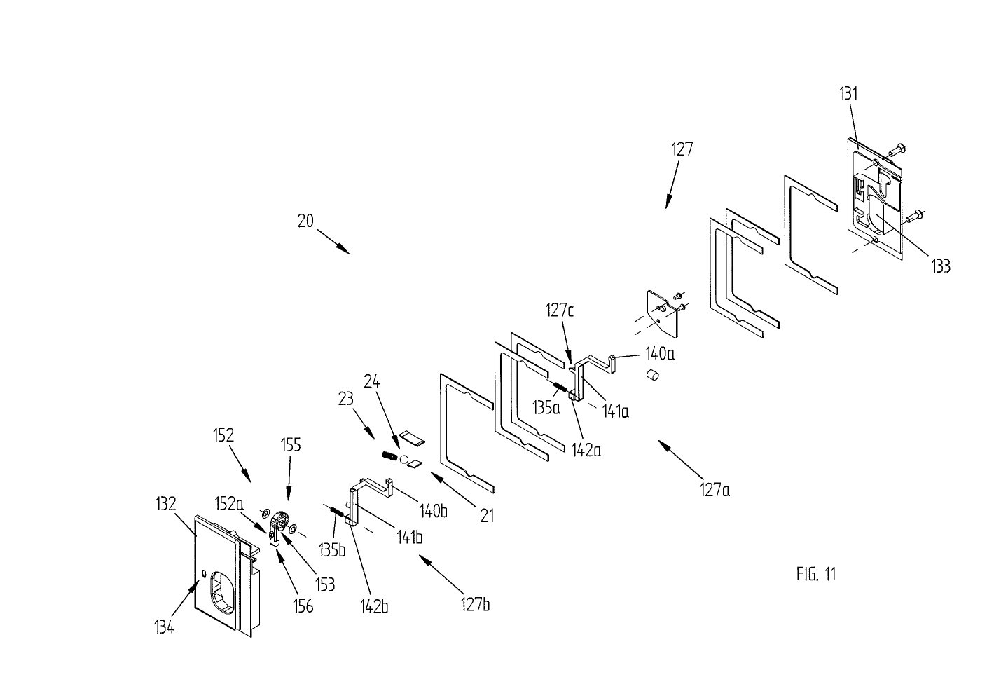

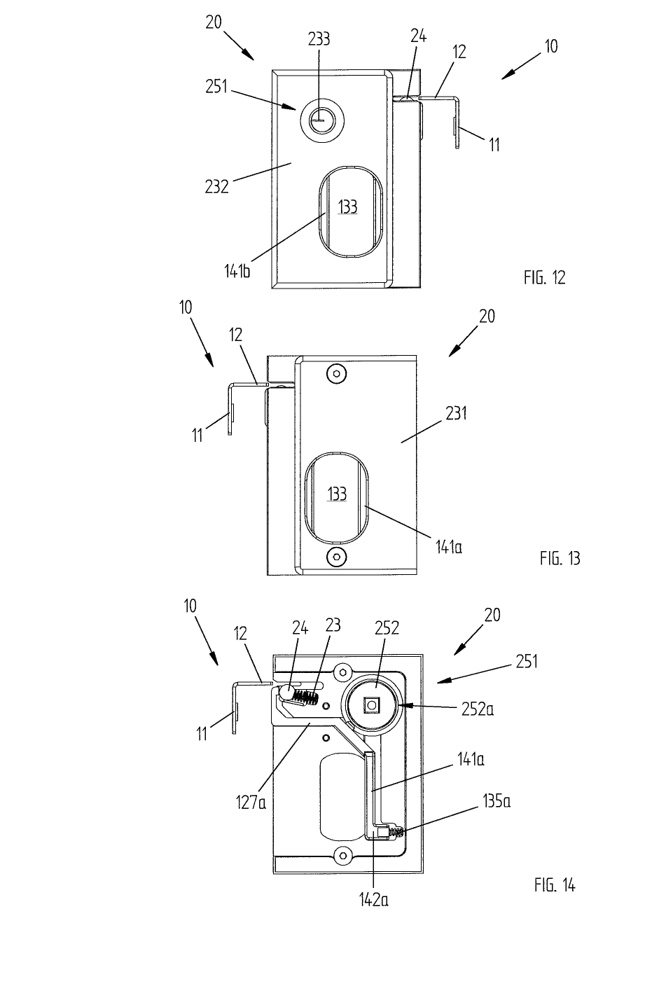

The locking element 152 preferably comprises a first manual operating portion, constituted by said knurled pawl 155, and a locking portion 156 defined by a shaped portion that when in said operative position is suited to be placed in contact with one of the two levers 127b to be locked, as shown in FIG. 10. In the locking position the lever 127b is locked and cannot translate, and therefore it cannot act on the rotatable element 24.

In the inoperative position, the locking portion 156 of the locking element 152 does not interfere with any of the two levers 127a, 127b, as shown in FIGS. 8 and 9, and the system of the invention operates normally, as described above.

The inoperative position of the locking element 152 according to the preferred embodiment illustrated herein is obtained according to two procedures. According to a first procedure, the locking element 152 is simply rotated by acting on the knurled pawl 155 in such a way that the locking portion 156 of the locking element 152 does not interfere with any one of the two levers 127a, 127b, as explained above.

According to a second procedure, the locking element 152 is rotated by acting directly on the first lever 127a, pulling it towards its open position, as shown in FIG. 10D. In this case, a portion 127c of the first lever 127a, preferably comprising an inclined surface, cooperates with a corresponding reference surface 153 of the locking element 152, said surfaces being visible in greater detail in FIGS. 10A and 10B.

When the first lever 127a is pulled, as shown in fact in FIG. 10D, the inclined surface 127c of the first lever 127 acts by pushing against the reference surface 153 of the locking element 152, thus causing it to rotate. The locking portion 156 of the locking element 152 moves from the locking position, shown in FIG. 10C, to the inoperative position, in which it does not interfere with any one of the two levers 127a, 127b, as explained above.

In a variant embodiment of the invention the safety locking means, when they are in their operative and locking position, may act on both of the levers, so that they are both locked and cannot act on the rotatable element.

In the embodiment described herein, the system is constructed in such a way that in case of emergency it is possible to act on the safety locking means 151 even from the side opposite that from which the pawl 155 is operated (for example, in order to be able to intervene if a user who is closed inside a room and has locked the panel 200 with the safety locking means 151 doesn't feel well).

The emergency release is obtained by making a hole 134 in the external plate 132 opposite the plate 131 from which the pawl 155 projects.

It is possible to act from the hole 134 to rotate the locking element 152 towards the inoperative position through the insertion of an emergency tool, for example a screwdriver bit.

The tool will act on a specific thrust point 152a along the locking element 152. Furthermore, the hole 134 makes it possible to see if the locking element 152 has been operated by a user, and thus to know, for example, if the room (toilet) has been closed from the inside (engaged toilet). From the hole 134, in fact, the thrust point 152a of the locking element 152 in this case will be clearly visible. Figures from 12 to 16 show another variant embodiment of the system according to the present invention.

This embodiment differs from the second embodiment previously described with reference to Figures from 6 to 11 due to the different construction structure of the safety locking means 251 of the handle 127.

The elements that are identical to and/or have the same characteristics as those described with reference to the first embodiment are indicated by the same reference numbers used above.

The safety locking means 251 are now constituted by a safety locking unit with key (the key is not illustrated in the drawings).

Said safety locking means 251 are now suited to be operated using a key and acting from one side of the system, more preferably inserting the key in the apposite slit 233 that can be accessed from one 232 of the two external closing to plates 231, 232.

The safety locking means 251 are advantageously operated by a user that is situated on one side of the door/window panel 200, for example outside a room, to lock and thus inhibit the action of one of the two levers 127a, 127b. In the embodiment illustrated herein, the safety locking means 251 inhibit the action of the lever 127b that is situated on the same side of the panel 200 on which there is the slit 233 for the key, and thus the movement of the lever towards the outside of the room. This is the particular case, for example, of a door that is locked by a user from the outside of a room to prevent anyone from entering by acting on the external lever, while allowing anyone who is inside the room to open the door by acting on the respective internal lever.

In variant embodiments of the invention, however, the safety locking means preferably inhibit the action of both levers.

The safety locking means 251, in fact, comprise a cylindrical element 252 suited to be operated through rotation by means of the key (not illustrated herein).

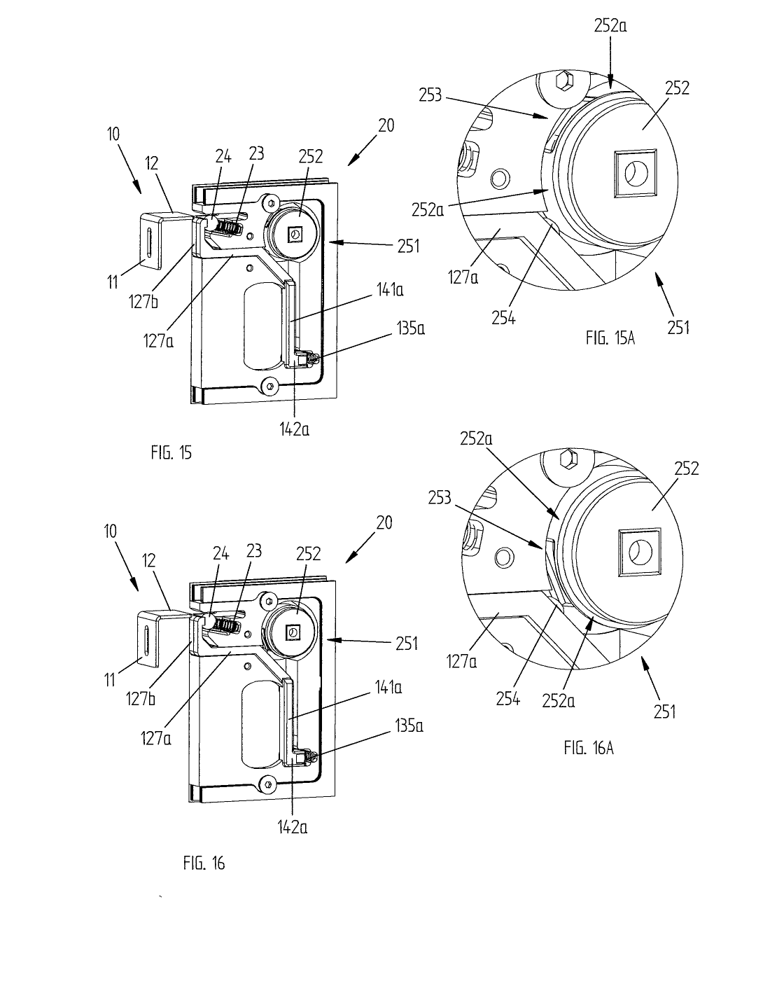

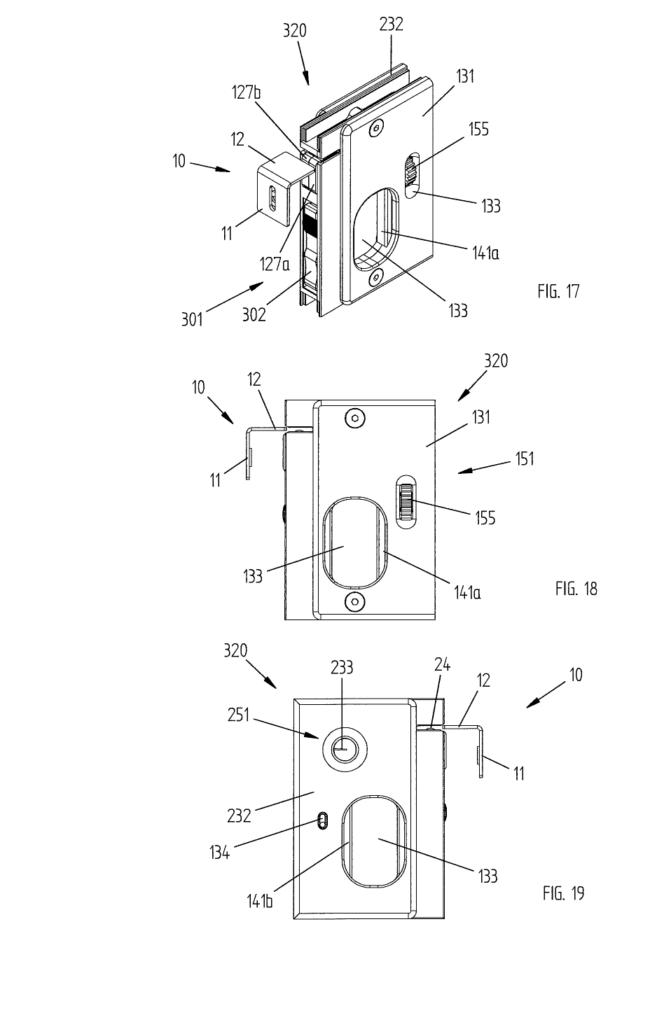

On the external surface 252a of the cylindrical element 252 there is a groove 253 suited to define a recessed area with respect to the external cylindrical surface 252a of the cylindrical element 252, as is visible in FIG. 15A.

The rotation of the cylindrical element 252 is suited to arrange the same cylindrical element 252 in at least two positions: an operative position, shown in FIG. 15A, in which its external cylindrical surface 252a abuts a projection 254 present on the lever 127b to be locked and an inoperative position, shown in FIG. 16A, in which the groove 253 is arranged at the level of said projection 254. In the inoperative position of the cylindrical element 252, the lever 127b is free to perform its translation movements.

More generally, in the inoperative position of the cylindrical element 252, the same cylindrical element 252 does not exert any action on the levers 127a, 127b. In the operative position of the cylindrical element 252, instead, the lever 127b is locked and cannot perform its rightward movement, therefore it cannot act on the rotatable element 24.

Figures from 17 to 23 show a further variant embodiment of the system according to the present invention.

This embodiment shows a system according to the present invention in which the several functions illustrated and described above with reference to the second and the third embodiment of the invention are present all together.

Therefore, it is possible to identify the following: the two levers 127a, 127b; first safety locking means 151 (of the manual type) with the corresponding emergency release system (hole 134); second safety locking means 251 with key.

This embodiment furthermore includes a drive system 301 suited to make it easier to move the panel 200, in particular when the panel 200 is completely open and inserted in the wall so that the opening 133 cannot be easily accessed by the user's fingers.

The drive system 301 comprises a small lever 302 preferably located in frontal position on the second component 320 and hinged at its upper end.

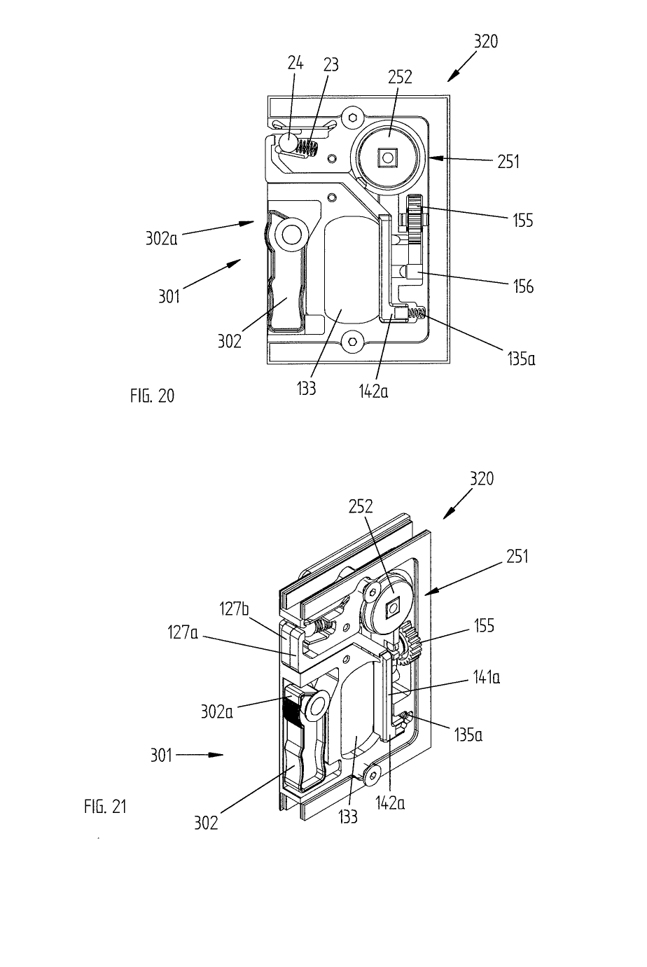

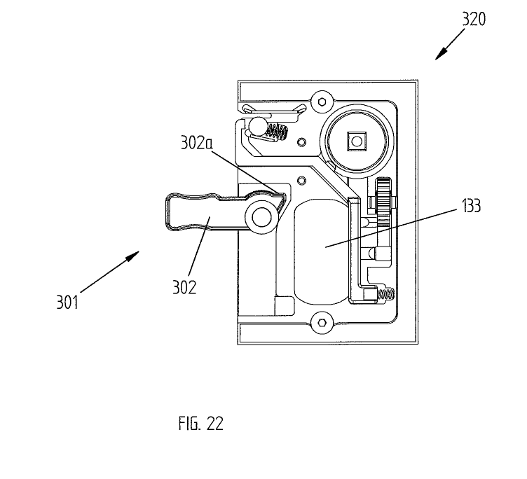

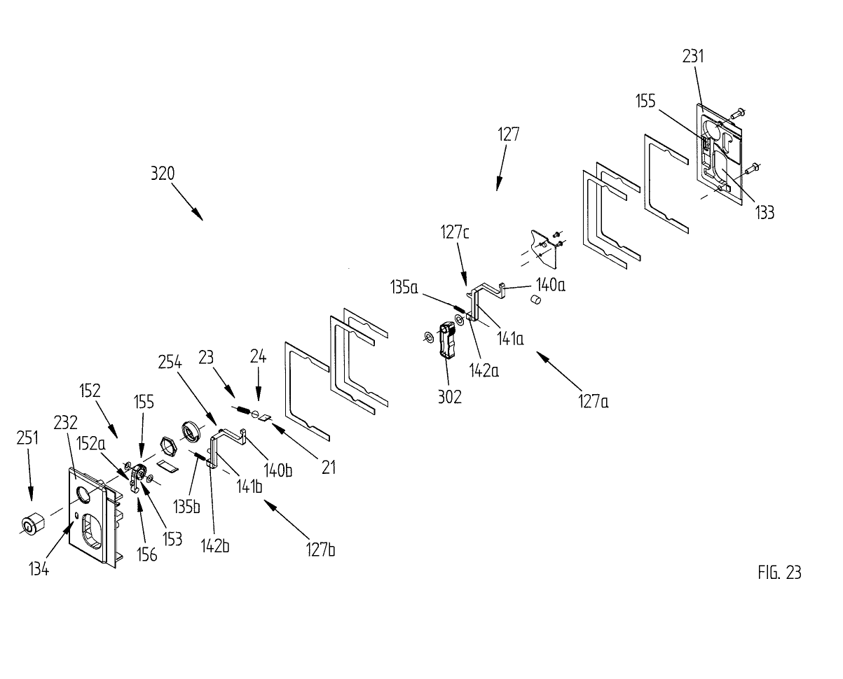

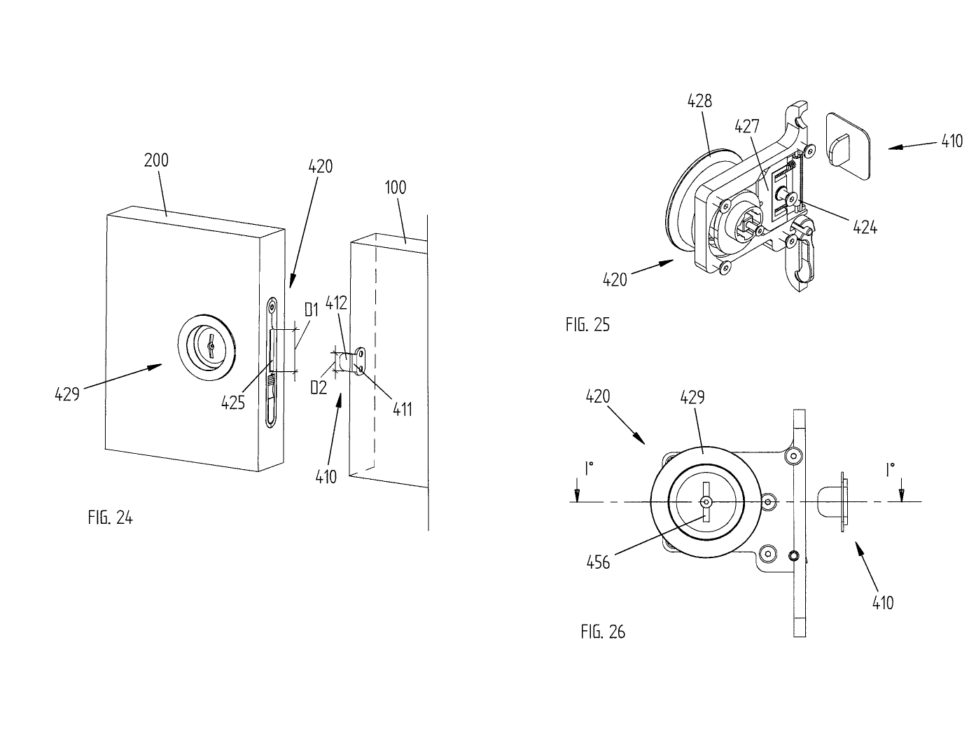

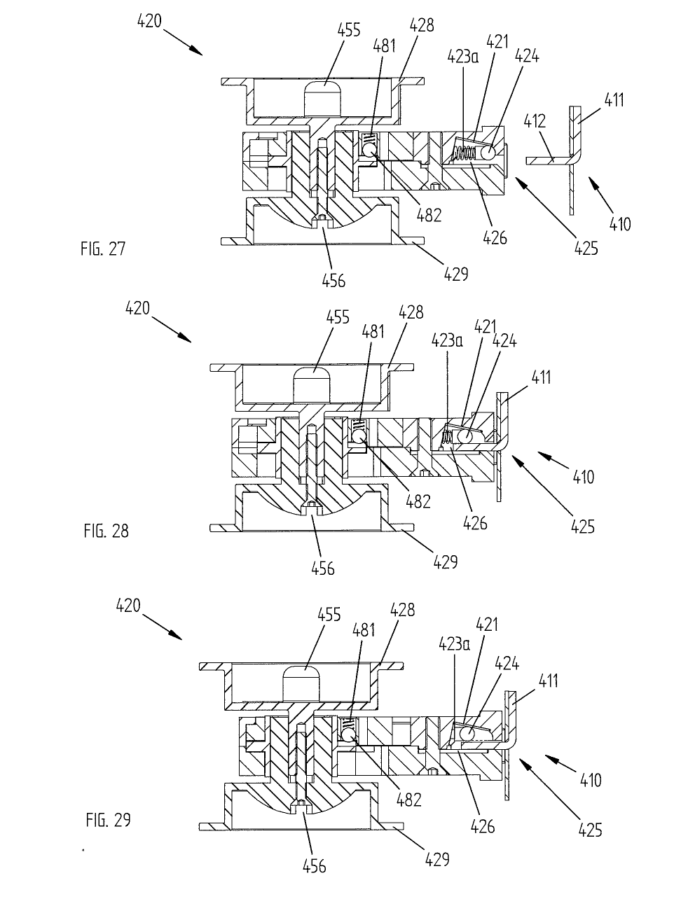

In normal conditions, for example as shown in FIGS. 20 and 21, the small lever 302 is positioned vertically. When it needs to be used to move the panel 200, it will be sufficient to rotate it, for example by acting on an upper thrust point 302a, so as to move it to a position in which it is easy to grasp it, as shown for example in FIG. 22.

A second example of application of the system according to the present invention is illustrated in Figures from 24 to 36.

Also in this case the element 100 is constituted by a vertical wall and the element 200 is constituted by a panel 200 for a sliding door.

This embodiment differs from the embodiment described above in that the rotatable and/or translatable element 424 is constituted by a cylindrical element, and not a ball, which is pushed by two helical springs 423a, 423b and is housed in the seat 426 provided in the second component 420, in such a way as to be oriented vertically.

Consequently, also the first component 410 is oriented vertically and comprises an end portion 411 through which the first component is fixed to the wall portion 100, as well as a second end portion 412 suited to be received and housed in a hollow seat 425 in a corresponding and complementary shape obtained in the second component 420.

Inside the second component 420 there is also a space 426 that on one side is delimited by a rigid portion 421 (for example, a metal strap) inclined with respect to the end portion 412 of the first component 410. In particular, analogously to the condition described with reference to the first embodiment of the invention, the end portion 412 is suited to translate within the seat 425 in such a way as to come into contact with the space 426 on the opposite side with respect to the inclined portion 421.

Preferably, the extension D1 in the vertical direction of the access area 425a to the hollow seat 425 exceeds the extension D2 in the vertical direction of the second end portion 412 of the first component 410. In this way, the introduction of the second end portion 412 in the hollow seat 425 is guaranteed over time even following any movement of the first component 410 with respect to said second component 420, for example in case of expansion and/or settling and/or slight vertical subsiding movements of the panel 200 with respect to the wall 100.

The operation of the connection system according to said embodiment of the invention is substantially as shown and described above.

The mutual connection of the first component 410 and the second component 420 is obtained through the mutual translation or sliding movement of the first component 410 towards the second component 420, meaning the sliding movement of the panel 200 towards its closed position.

FIG. 27 shows the situation with the components 410 and 420 disengaged from each other.

FIG. 28 shows the situation with the components 410 and 420 engaged with each other and the mutual locking configuration between the first component 410 and the second component 420, in such a way as to mutually lock the two elements 100 and 200 in a predefined position.

FIG. 29 shows the release condition. In this condition releasing means 450, illustrated and described in greater detail below, push the rotatable and translatable element 424 towards the inside of the component 420 and thus towards the portion of the space 426 in which the distance between the rigid portion 421 and the end 412 increases. In this way, therefore, the opposing movement (friction) between the external surface of the rotatable-translatable element 424 and the surface of the end 412 facing towards the rigid portion 421 will decrease, even to the extent of being completely eliminated in the position in which the rotatable and translatable element 424 is no more in contact with the end 412.

In the preferred embodiment of the invention illustrated and described herein, the releasing means 450 first of all comprise one pair of operating elements 428, 429, each one of which can be accessed from one side of the panel 200.

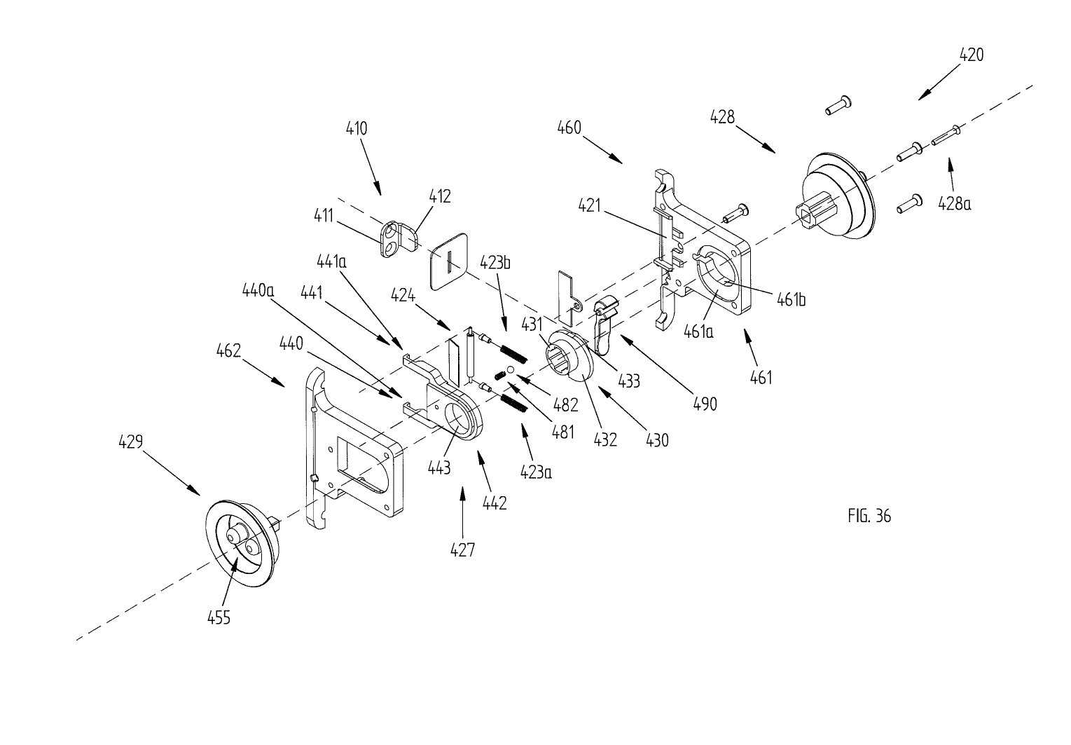

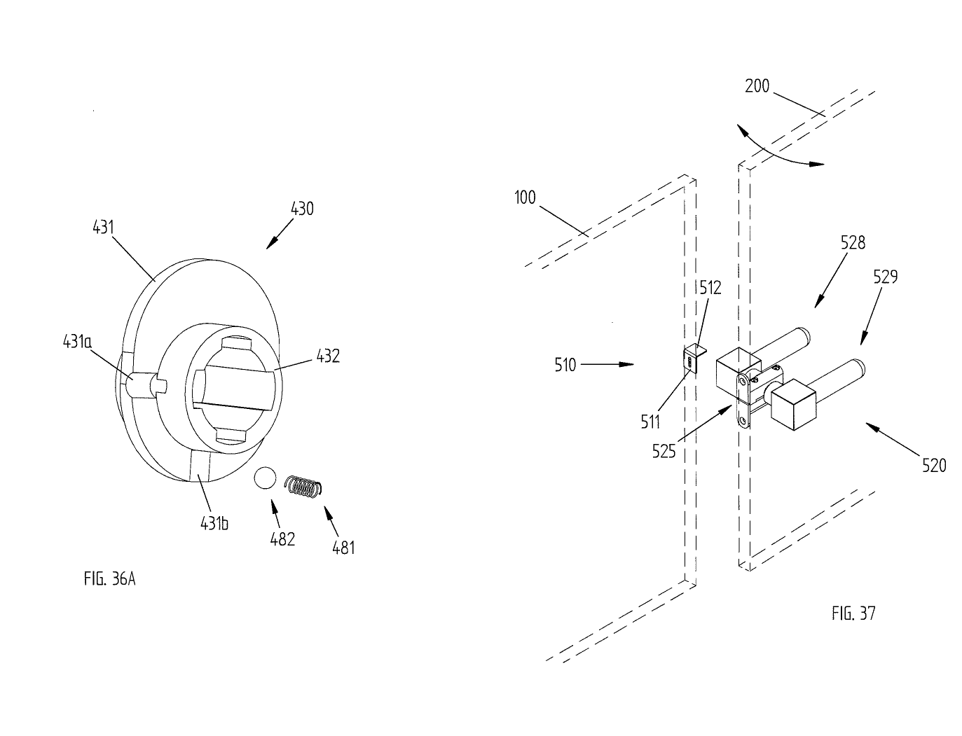

The first operating element 428 is preferably made in the shape of a bushing and is arranged in such a way that it is recessed in the panel 200 and that it can both be translated in a first substantially horizontal direction and rotated by acting on suitable gripping elements 455, visible in FIG. 36.

The second operating element 429 is preferably made in the shape of a bushing and is arranged in such a way that it is recessed in the panel 200 and that it can both be translated in a first substantially horizontal direction and rotated by acting with a special tool (for example, a coin) on an apposite slit 456.

The two operating elements 428, 429 are integral with each other in their movements and are preferably screwed together (through a screw 428a).

The operating elements 428, 429 are integral with an interconnection element 430. The interconnection element 430 interacts with a releasing element 427.

The interconnection element 430 comprises a first cylindrical portion 431, a non-cylindrical or eccentric shaped external surface portion 432, and a second cylindrical portion 433.

The interconnection element 430 is housed, in particular, in a seat 461 of a supporting body 460 in which part of the hollow seat 425 (with the respective rigid portion 421) is obtained.

More particularly, the seat 461 comprises a first elongated portion 461a suited to accommodate the eccentric external surface 432 of the interconnection element 430 and a second elongated portion 461b suited to accommodate the second cylindrical portion 433 of the interconnection element 430.

The supporting body 460 is associated with a closing element 462 whose shape matches the shape of the supporting body 460 in order to enclose and support the various elements that make up the second component 420.

The releasing element 427 comprises one pair of arms 440, 441 suited to be placed in contact with the rotatable element 424 through their ends 440a, 441a. The releasing element 427 comprises also a main portion 442 provided with a circular hole 443 suited to accommodate the first cylindrical portion 431 of the interconnection element 430.

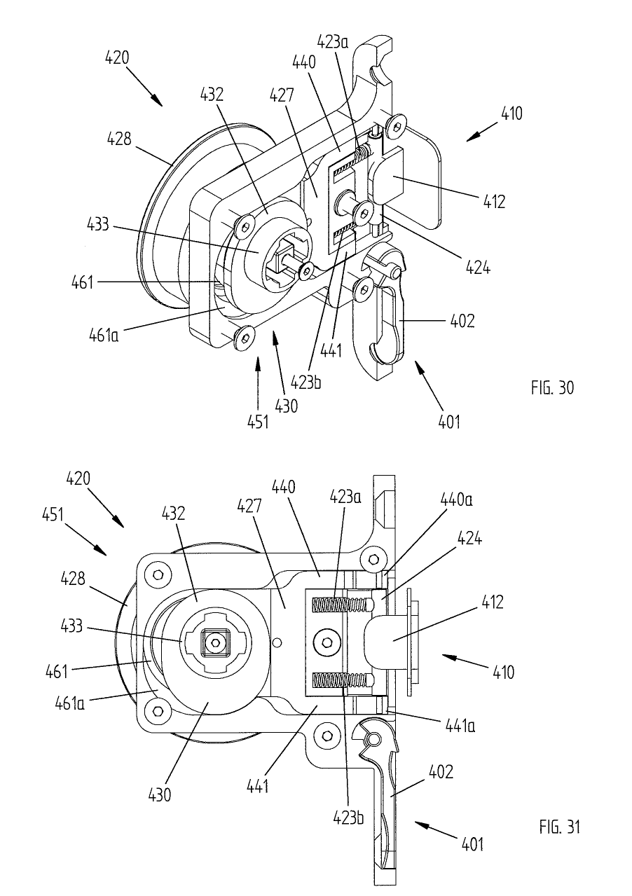

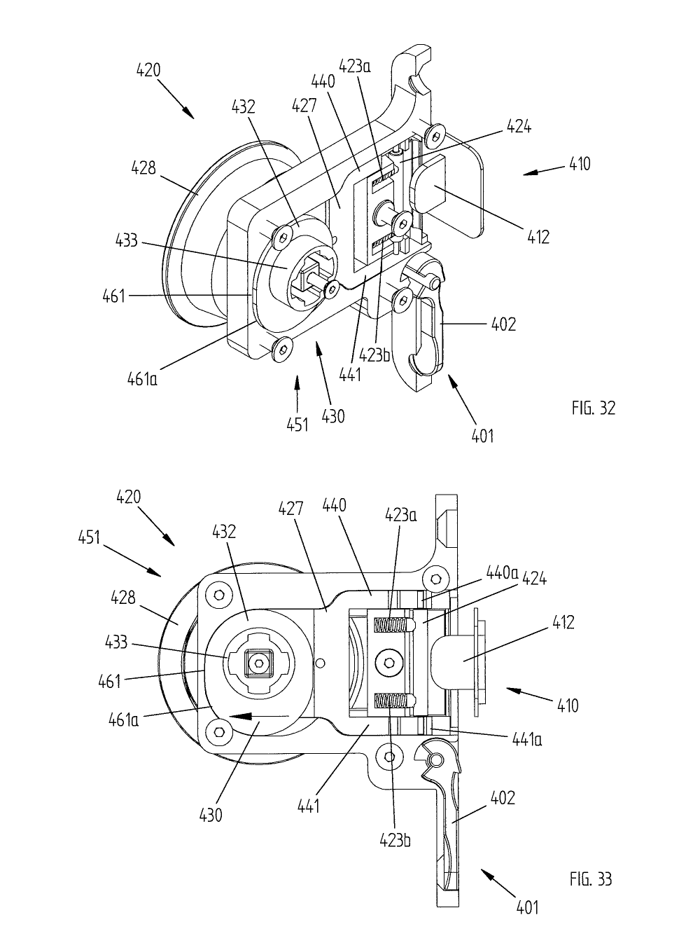

The releasing element 427, in particular, is suited to be translated towards the inside of the component 420 through the action exerted by the user on one of the two operating elements 428, 429, and thus through the traction exerted by the user on the main portion 441 of the releasing element 427 by means of the interconnection element 430. This can be observed by comparing the inoperative configuration shown in FIGS. 30 and 31 with the operative position shown in FIGS. 32 and 33 obtained when one of the knobs 428, 429 is operated.

The interconnection element 430, therefore, is free to translate inside the seat 461 in the supporting base 460 until reaching its final position, which is shown in FIGS. 32 and 33.

Therefore, a user who, for example, wishes to open the panel 200 by acting directly on said panel 200 without acting on one of the two operating elements 428, 429 will not be able to obtain the mutual release of the second component 420 and the first component 410 from each other and thus will not be able to open said panel 200. The mutual release of the two components 410 and 420, and thus the opening of the panel 200, will therefore be obtained by pulling one of the two operating elements 428, 429 from right to left as shown in FIGS. 29 and 33, and thus in such a way as to translate the releasing element 427 towards the inside of the second component 420. In fact, during its translation towards the inside of the second component 420, the releasing element 427 will push the rotatable and translatable element 424 with the ends 440a, 441a of the arms 440, 441 towards the inside of the component 420, and thus towards the portion of the space 426 in which the distance between the portion 421 and the end 412 increases. In this way, therefore, the opposing movement (friction) between the external surface of the rotatable and translatable element 424 and the surface of the end 412 facing towards the rigid portion 421 will decrease, even to the extent of being completely eliminated in the position in which the rotatable and translatable element 424 is no more in contact with the end 412.

When the operating elements 428, 429 are released, they are advantageously brought back to the inoperative position (FIGS. 30 and 31) in the direction contrary to the direction of traction, through the action of the helical springs 423a, 423b that act according to the path constituted by the rotatable and translatable element 424, the releasing element 427 with its arms 440, 441 and the interconnection element 430.

Even this embodiment preferably comprises also safety locking means 451 for the operating elements 428, 429.

In particular, the safety locking means 451 can be operated manually from one side of the panel 200 by rotating the first operating element 428 by means of the gripping elements 455 and from the other side of the panel 200 by rotating the second operating element 429 by acting on the slit 456 with a suitable tool (for example, a coin).

The operation of the safety locking means 451 according to the procedures illustrated above determines the rotation of the interconnection element 430.

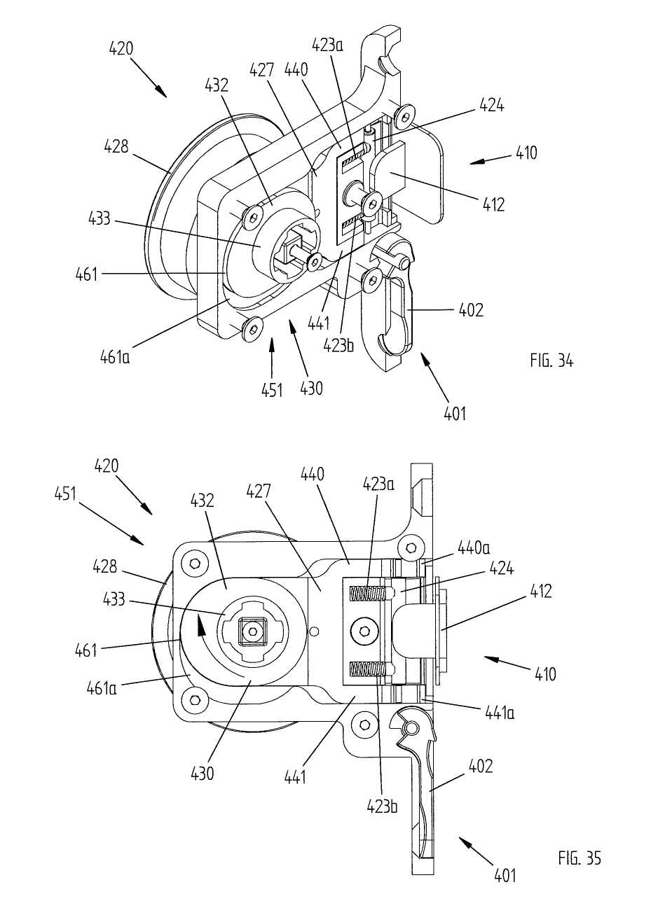

In particular, the rotation of the interconnection element 430 determines the rotation of its eccentric external surface 432 inside the first elongated portion 461, this situation being illustrated in particular in FIGS. 34 and 35.

The position of the eccentric external surface 432 inside the first elongated portion 461 prevents any translation movement of the interconnection element 430 with respect to the supporting base 460. This prevents any translation movement of the operating elements 428 and 429 and of the releasing element 427 with respect to the supporting base 460.

The release of the safety locking means 451 will be obtained by rotating the first operating element 428 in the opposite direction, through the gripping elements 455, or by rotating the second operating element 429 acting on the slit 456 with a tool (for example, a coin).

In order to maintain the two operating elements 428, 429 in their extreme positions after rotation, the system advantageously comprises a holding system that preferably comprises a spring 481 and a ball 482. The holding ball 482 is housed in said extreme positions of the operating elements 428, 429 in corresponding seats 431a and 431b of the interconnection element 430, shown in particular in FIG. 36A. Furthermore, the snapping movement of the ball 482 inside the corresponding seat 431a, 431b allows the user to perceive that the rotation has been performed and that the desired extreme position of the operating element 428, 429 has been reached.

Finally, even this embodiment includes a drive system 401 comprising a small lever 402 suited to make it easier to pull the panel 200.

A third example of application of the system according to the present invention is shown in Figures from 37 to 46.

In this case the connection system is associated with a panel 200 for a single, non-sliding door.

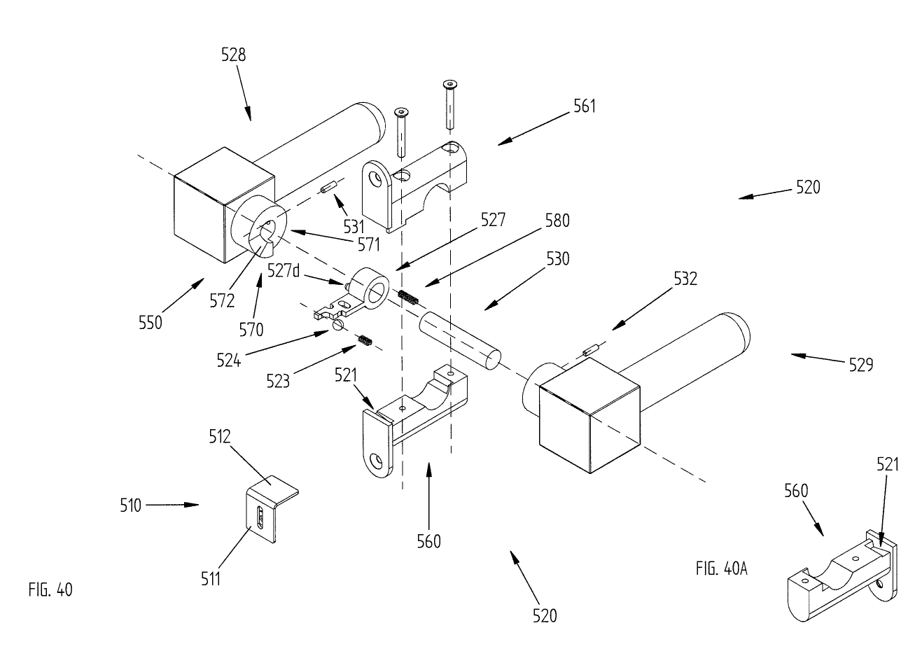

Analogously to the first embodiment of the invention, the first component 510 comprises an end portion 511 through which the first component itself is fixed to the wall portion 100, as well as a second end portion 512 suited to be housed in a hollow seat 525 in a corresponding and complementary shape obtained in the second component 520. Inside the second component 520 there is also a space 526 delimited on one side by a portion 521 (better visible in FIG. 40A) that is inclined with respect to the end portion 512 of the first component 510. In particular, the end portion 512 is suited to translate inside the seat 525 in such a way as to come into contact with the space 526 on the opposite side with respect to the inclined portion 521. In the case of a single door, differently from that which happens with sliding doors, the end portion 512 fits into the second component 520 laterally.

Inside the space 526 there is a rotatable and translatable element 524, a ball, located at the level of the free end of a helical spring 523 in such a way that the helical spring 523 exerts a thrusting action on said rotatable element 524 towards the end of the space 526 in which the distance between the inclined portion 521 and the end 512 decreases.

Concerning the way in which the first component 510 is engaged with the second component 520, this is substantially the same as previously described with reference to the first embodiment of the invention.

The mutual connection of the first component 510 and the second component 520 is obtained through the mutual translation or sliding movement of the first component 510 towards the second component 520, that is, by closing the panel 200 rotating it towards its closed position.

During said approaching movement, the end portion 512 of the first component 510 slides towards the inside of the second component 520 until reaching its final position inside the component 520, shown in FIG. 44. The final position defines the mutual locking condition between the first component 510 and the second component 520, in such a way as to mutually lock the two elements 100 and 200 in a pre-defined position.

The system 501 comprises also releasing means 550, better illustrated and described below, that push the rotatable and translatable element 524 towards the inside of the component 520 and therefore towards the portion of the space 526 in which the distance between the inclined portion 521 and the end 512 increases. In this way, therefore, the opposing movement (friction) between the external surface of the rotatable and translatable element 524 and the surface of the end 512 facing towards the inclined portion 521 will decrease, even to the extent of being completely eliminated in the position in which the rotatable and translatable element 524 is no more in contact with the end 512.

In the preferred embodiment of the invention illustrated and described herein, the releasing means 550 first of all comprise one pair of operating elements 528, 529 arranged on opposite sides of the panel 200.

The first operating element 528 is preferably made in the shape of a handle and is arranged on the panel 200 so that it can rotate.

Analogously, the second operating element 529 is preferably made in the shape of a handle and is arranged on the panel 200 so that it can rotate.

The two operating elements 528, 529 are made integral to each other in their rotation movements through an interconnection pin 530, to which the operating elements 528, 529 are fixed through locking dowels 531, 532.

One of the operating elements 528, the left one in the figures, is associated with a thrusting element 570 that is integral with the operating element 528 that acts on a releasing element 527.

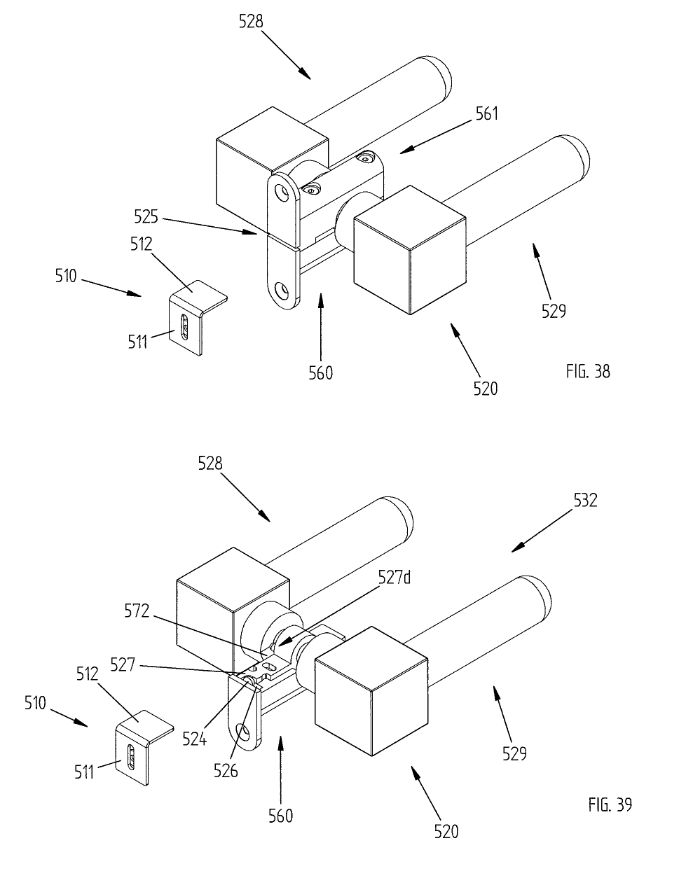

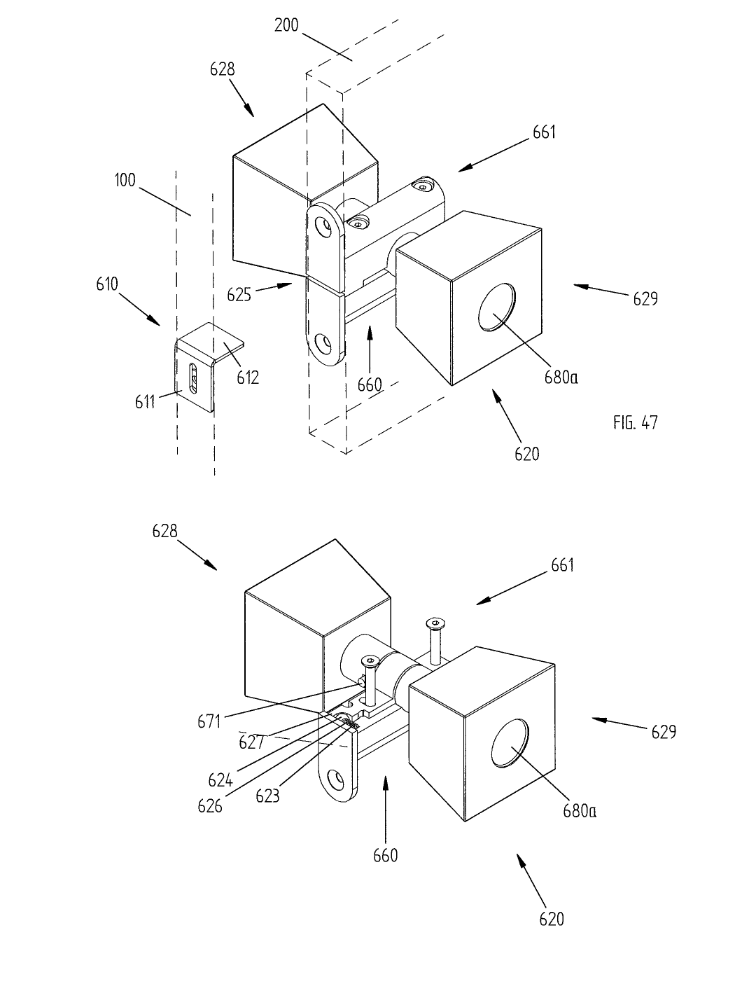

The thrusting element 570 is constituted by a cylindrical portion 571 comprising an oblique thrusting portion 572 (cam) suited to act so as to push the releasing element 527 during the rotation of one of the two operating elements 528, 529, as can be observed, for example, when comparing FIGS. 39 and 46. The cam 572 acts on a small projection 527d of the releasing element 527.

The thrusting action of the releasing element 527 causes the rotatable and translatable element 524 to translate and pushes it towards the inside of the component 520 and thus towards the portion of the space 526 in which the distance between the portion 521 and the end 512 increases. In this operating condition, as extensively explained with regard to the previous embodiments of the invention, the first component 510 can be separated from the second component and therefore the panel 200 can be rotated in order to be opened.

It can thus be understood from the above description that a user will be able to open the panel 200 by simply rotating one of the two handles 528, 529, allowing first the mutual release of the two components 520 and 510 of the system, and then the opening of the panel 200 itself. Once the two components 520 and 510 have been released, the handle 528 or 529 that was previously rotated can be released so that it returns to its initial, substantially horizontal position.

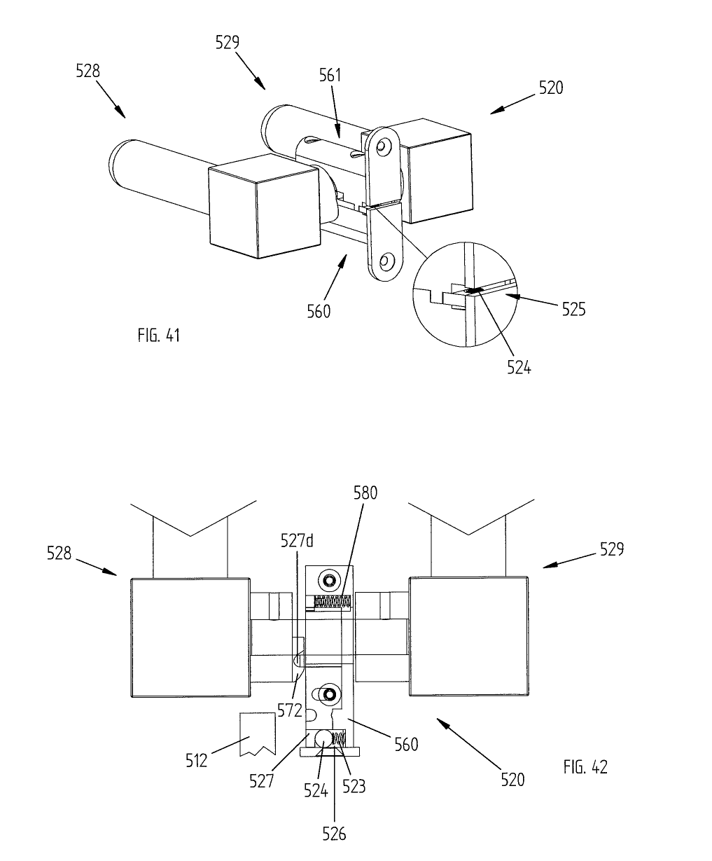

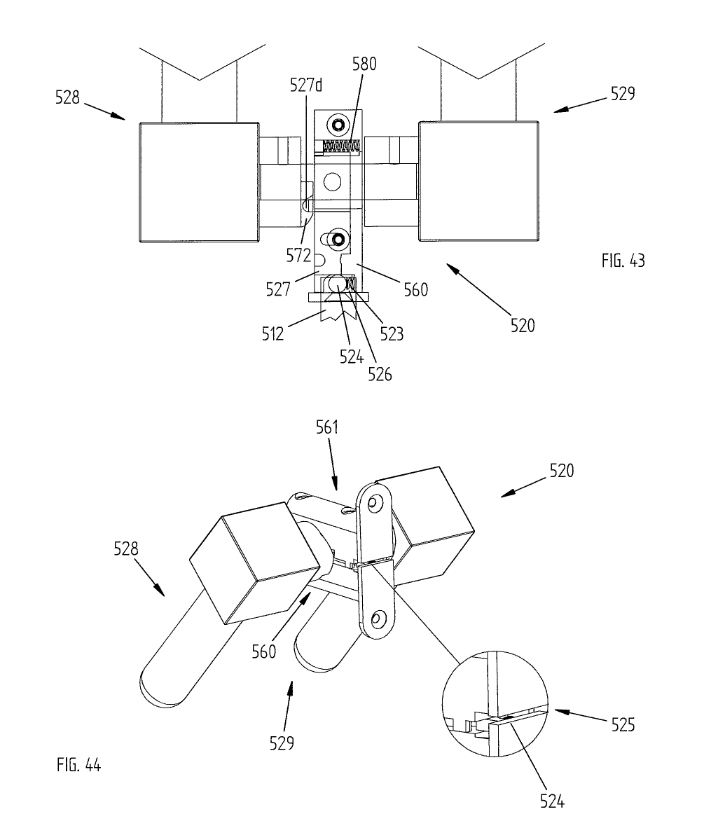

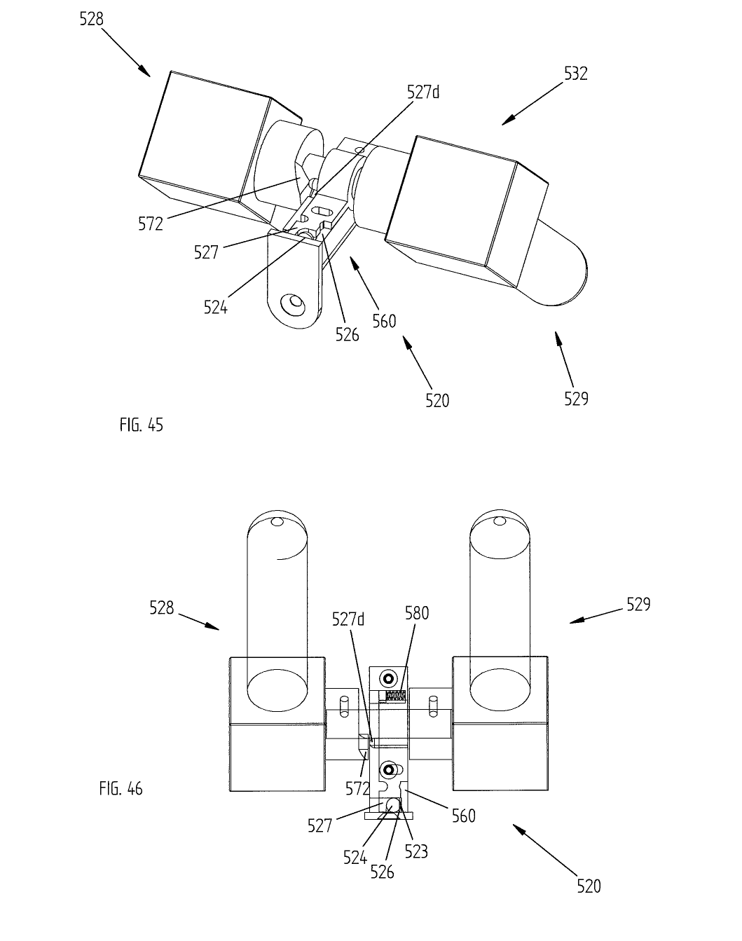

In order to make it easier to restore the initial condition and to have the releasing element 527 return to the rest condition, for example the condition shown in FIG. 42, a return spring 580 is provided, which is suited to act on the releasing element 527 itself in the release direction, that is, leftwards, always with reference to FIG. 42.

The restoration of the initial condition and the return of the releasing element 527 to the rest position are also favoured by the action of the helical spring 523 associated with the rotatable and translatable element 524.

On the contrary, any attempt to open the panel 200 without acting on one of the two handles 528, 529 will result in the mutual engagement of the two components 520 and 510 of the system.

Once the two components 520 and 510 have been released, the thrusting element 570 is constituted by a cylindrical portion 571 comprising an oblique thrusting surface 572 (cam) that is suited to act so as to push the releasing element 527 during the rotation of one of the two operating elements 528, 529, as can be observed, for example, when comparing FIGS. 39 and 46. The cam 572 acts on a small projection 527d of the releasing element 527.

A fourth example of application of the system according to the present invention is illustrated in Figures from 47 to 60.

Also in this embodiment the connection system is associated with a panel 200 for a single door.

Analogously to the third embodiment of the invention, the first component 610 comprises an end portion 611 through which the first component itself is fixed to a wall portion, as well as a second end portion 612 suited to be housed in a hollow seat 625 in a corresponding and complementary shape obtained in the second component 620. Inside the second component 620 there is also a space 626 delimited on one side by a rigid portion 621 that is inclined with respect to the end portion 612 of the first component 610. In particular, the end portion 612 is suited to translate, in a way that is analogous to that described with reference to the third embodiment of the invention, inside the seat 625 which houses a rotatable and translatable element 624, a ball, located at the level of the free end of a helical spring 623.

The system 601 comprises also releasing means 650, illustrated and described in greater detail below, suited to push the rotatable and translatable element 624 towards the inside of the component 620 (as shown in FIG. 51).

In the preferred embodiment illustrated and described herein, the releasing means 650 comprise first of all one pair of operating elements 628, 629 arranged on opposite sides of the panel 200.

The first operating element 628 is preferably made in the shape of a knob and is arranged on the panel 200 in such a way that it can be translated horizontally in a direction that is substantially perpendicular to the plane of the panel 200.

Analogously, the second operating element 629 is preferably made in the shape of a knob and is arranged on the panel 200 in such a way that it can be translated horizontally in a direction that is substantially perpendicular to the plane of the panel 200.

The two operating elements 628, 629 are interconnected through an interconnection element 630. One of the operating elements, the left one 628 in the figures, is fixed to the interconnection element 630 through a locking dowel 631. The other operating element, the right one 629 in the figures, is connected to the interconnection element 630 through a dowel 632 that is screwed onto the operating element 629. The head of said dowel 632 can slide inside a slit 630b that is provided in the underside of the interconnection element 630 and is visible in greater detail in FIG. 60. The right operating element 629 can therefore move with respect to the interconnection element 630 for a distance corresponding to the longitudinal development of said slit 630b.

According to a variant embodiment of the invention, the slit may be made in the operating element, while the dowel may get engaged in the interconnection element.

The interconnection element 630 is associated with a thrusting element 670 that acts on a releasing element 627.

The releasing element 627 comprises an end 627a suited to be placed in contact with the rotatable and translatable element 624 and a centre portion 627b provided with a hole 627c that is suited to accommodate the interconnection element 630.

The centre portion 627b of the releasing element 627 is housed, in particular, between a lower supporting body 660 and an upper supporting body 661. Part of the hollow seat 625 and the respective inclined portion 621 are obtained in the lower supporting body 660.

The lower supporting body 660 and the upper supporting body 661 are properly fixed to the door/window panel 200, preferably by means of screws.

The thrusting element 670 is constituted by a pin that is suited to abut the releasing element 627 during the translation of one of the two operating elements 628, 629.

The translation movement is obtained by pushing the left knob 628 towards the panel 200 or by pulling the right knob 629 towards the outside with respect to the panel 200.

The thrusting action of the releasing element 627 causes the translation of the rotatable and translatable element 624 and pushes it towards the inside of the component 620 to reach a configuration in which the first component 610 can be separated from the second component 620 and thus the panel 200 can be opened. It can thus be understood from the explanation provided above that a user will be able to open the panel 200 by simply pushing the left knob 628 towards the panel 200 or pulling the right knob 629 in the direction away from the panel 200. Once the two components 620 and 610 have been released, the knob 628 or 629 previously operated can be released and return to its initial position.

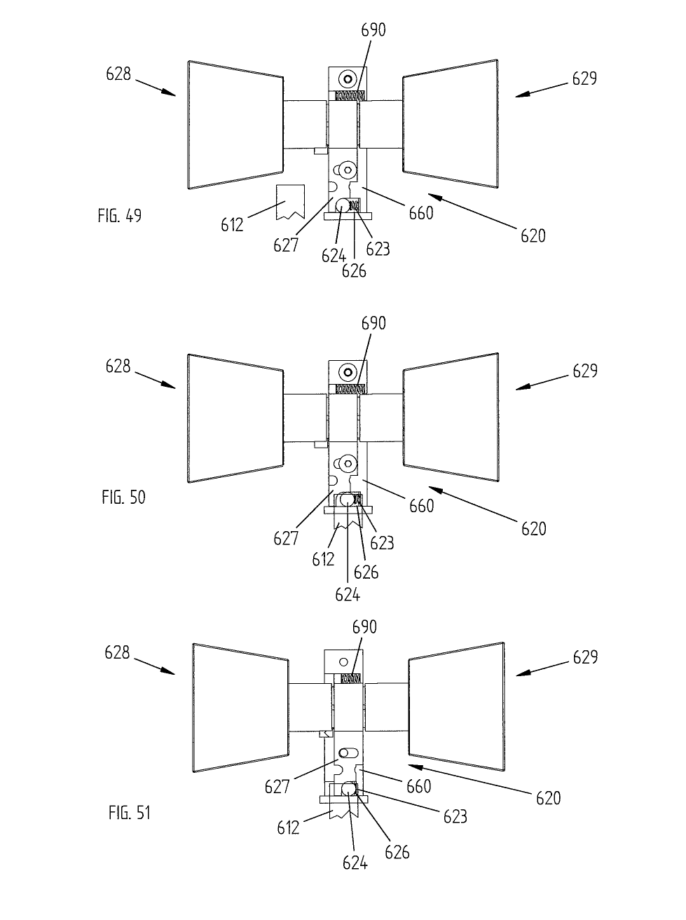

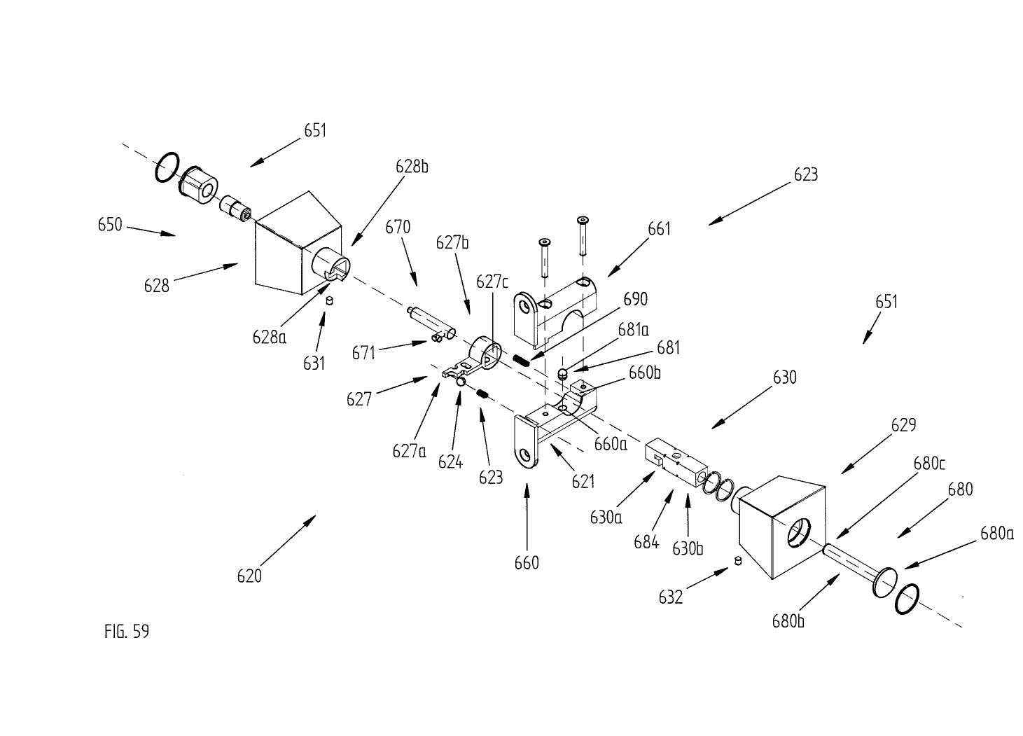

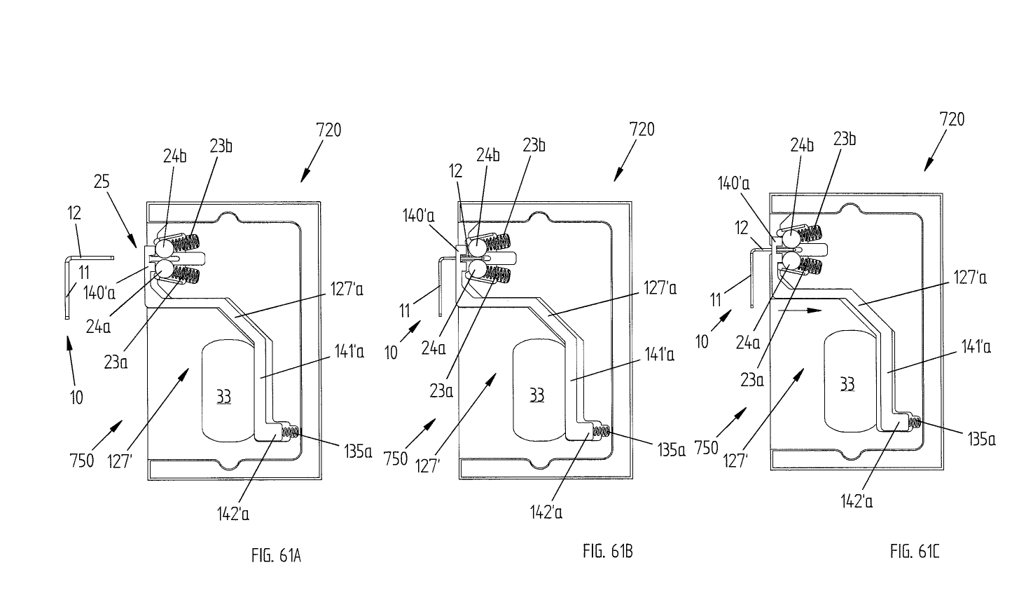

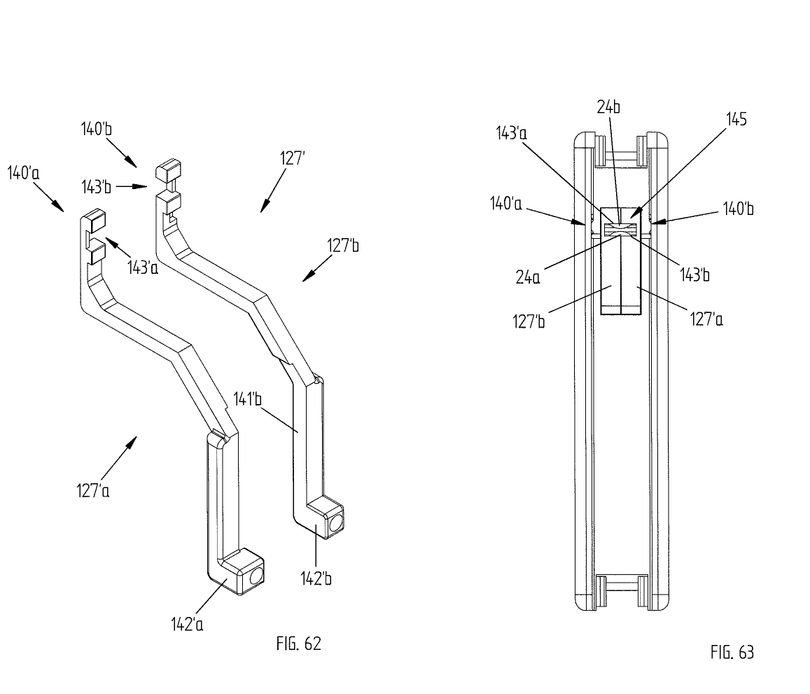

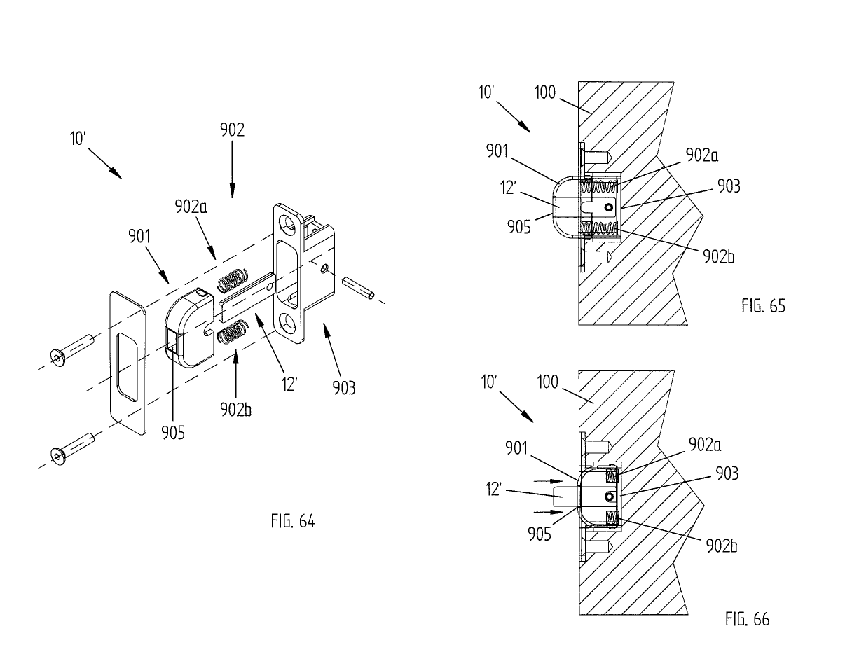

In order to make it easier to restore the initial condition and favour the return of the releasing element 627 to the rest condition, for example the condition shown in FIG. 49, there is a return spring 690 that is suited to act on the releasing element 627 in the release direction, meaning to the left, always with reference to FIG. 49. The return spring 690 is advantageously housed in a seat 660b in the lower supporting body 660, visible in greater detail in FIG. 59.

The restoration of the initial condition and the return of the releasing element 627 to the rest condition is furthermore favoured also by the action of the helical spring 623 associated with the rotatable and translatable element 624.

On the contrary, any attempt to open the panel 200 without acting on one of the two knobs 628, 629 will result in the mutual locking of the two components 620 and 610 of the system.

According to the present embodiment, the system that is the subject of the invention preferably comprises safety locking means 651 for the knobs 628, 629. In particular, the safety locking means 651 can be operated from one side of the panel 200 at the level of the left knob 628 through a key (not illustrated in the drawings) and from the other side of the panel 200 at the level of the right knob 629 through a button 680.

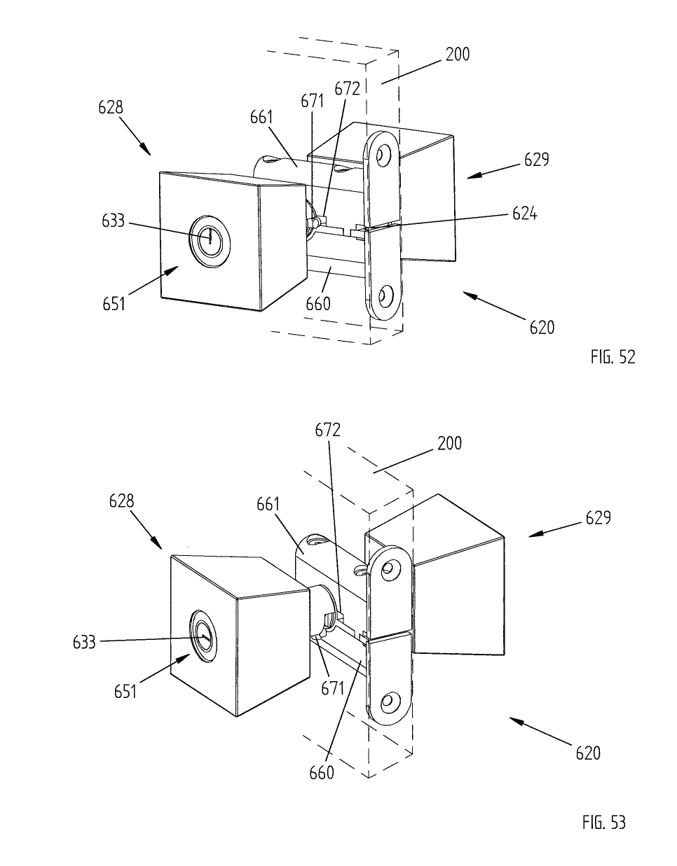

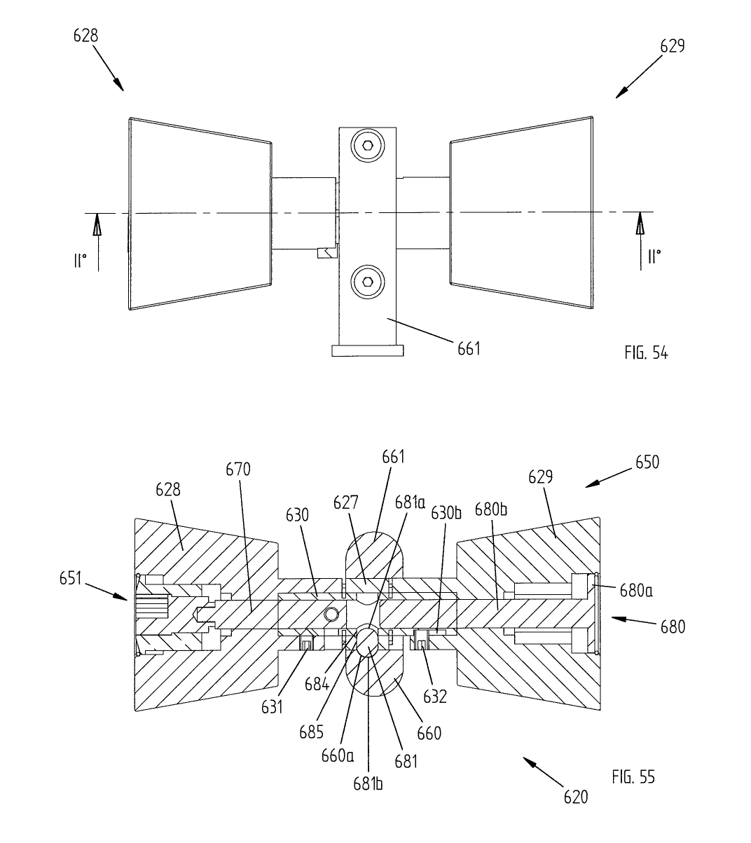

The safety locking means 651 can therefore be operated with a key by acting on one side of the system, more preferably by inserting the key in the appropriate slit 633 (FIGS. 52 and 53).

The rotation of the key through an appropriate key lock, known per se and not described in detail herein, rotates the thrusting element 670, as shown in FIG. 53. The thrusting element 670 is provided with a projecting pawl 671 that in the configuration with the knobs 628, 629 in the inoperative position is advantageously arranged externally with respect to the lateral surface of the lower support 660 and of the upper support 661, as can be observed in FIG. 52. When the knobs 628, 629 are pushed or pulled as described above, the projecting pawl 671 can slide inside a suitable slit 672 that is provided in the upper support 661. Therefore, no movement of the knobs 628, 629 is inhibited to allow the opening of the panel 200 (according to the procedures described above).

On the other hand, when the thrusting element 670 is rotated by means of the key, the projecting pawl 671 rotates freely with respect to the interconnection element 630 inside a slit 630a provided therein and abuts the external lateral surface of the lower support 660, as explained above and visible in FIG. 53. The extent of the rotation of the thrusting element 670 and of the projecting pawl 671 in terms of rotation angle is defined by the shaped portion 628a created on the tubular extension 628b of the left knob 628, as shown in FIG. 59. Preferably, said rotation angle is a 90° angle.

The new position of the thrusting element 670, which is locked and cannot translate horizontally, in turn inhibits the translation of the interconnection element 630 and therefore of the knobs 628, 629 connected to it.

The opening of the door/window panel 200 is therefore prevented due to the locked condition of the two knobs 628, 629.

Acting again on the key in the opposite direction returns the thrusting element 670 and the projecting pawl 671 in the inoperative position shown in FIG. 52, actually releasing the system.

It can be noticed that during the translation of the releasing element 627 to act on the rotatable and translatable element 624, the same releasing element 627 together with the interconnection element 630 and the knobs 628, 629 translate with respect to the lower and upper supports 660, 661.

In practice, the locking system with key described above inhibits the movement of the releasing element 627, of the interconnection element 630 and of the knobs 628, 629 with respect to the lower and upper supports 660, 661.

The locking system with button 680 at the level of the right knob 629 is based on the same principle aimed at inhibiting the movement of the releasing element 627, of the interconnection element 630 and of the knobs 628, 629 with respect to the lower support 660.

The button 680 comprises an end portion 680a suited to be operated by the user with a thrusting action and a centre portion 680b, preferably cylindrical, housed inside the interconnection element 630. The end 680c of the centre portion 680b is suited to act on a locking element 681, as shown in particular in the locked configuration illustrated in FIG. 57. The locking element 681 preferably comprises a roller with a rounded end 681a suited to come into contact with the end 680c of the button 680 and the opposite end 681b suited to be accommodated in a matching seat 660a provided in the lower support 660. The locking element 681 is housed in aligned holes 684, 685 respectively obtained in the interconnection element 630 and in the centre portion 627b of the releasing element 627.

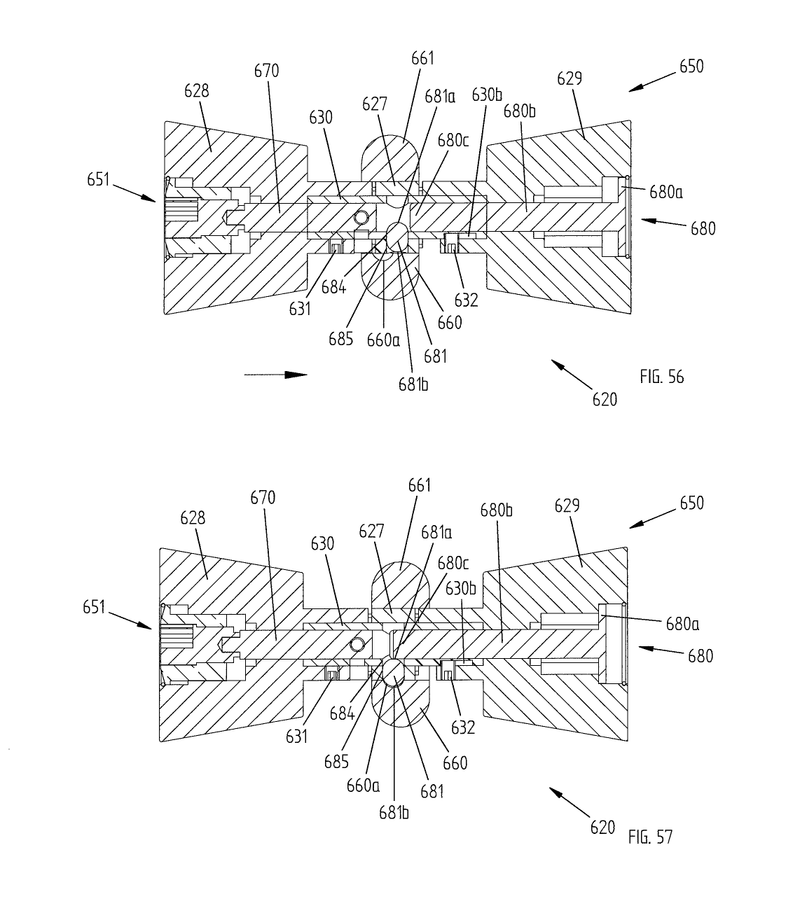

When the button 680 is in the inoperative position, the locking element 681 does not interfere with the normal operation of the system. As can be observed by comparing FIGS. 55 and 56, which show the effect of the operation of the left knob 628, in fact, the locking element 681 moves freely out of the seat 660a provided in the lower support 660 and allows the normal translation of the releasing element 627 with the interconnection element 630 and the knobs 628, 629 with respect to the lower support 660.

When, on the other hand, the button 680 is pressed and brought to its operative position, as shown in FIG. 57, the end 680c of the button 680 locks the locking element 681 in the seat 660a provided in the lower support 660 and, consequently, prevents any mutual movement between the lower support 660, the releasing element 627 and the interconnection element 630.

In this condition, also the left knob 628 is locked with respect to the lower support 660 and consequently the system is locked.

The system is released by moving the button 680 to a position in which its ends 680c does not prevent the movement of the locking element 681.

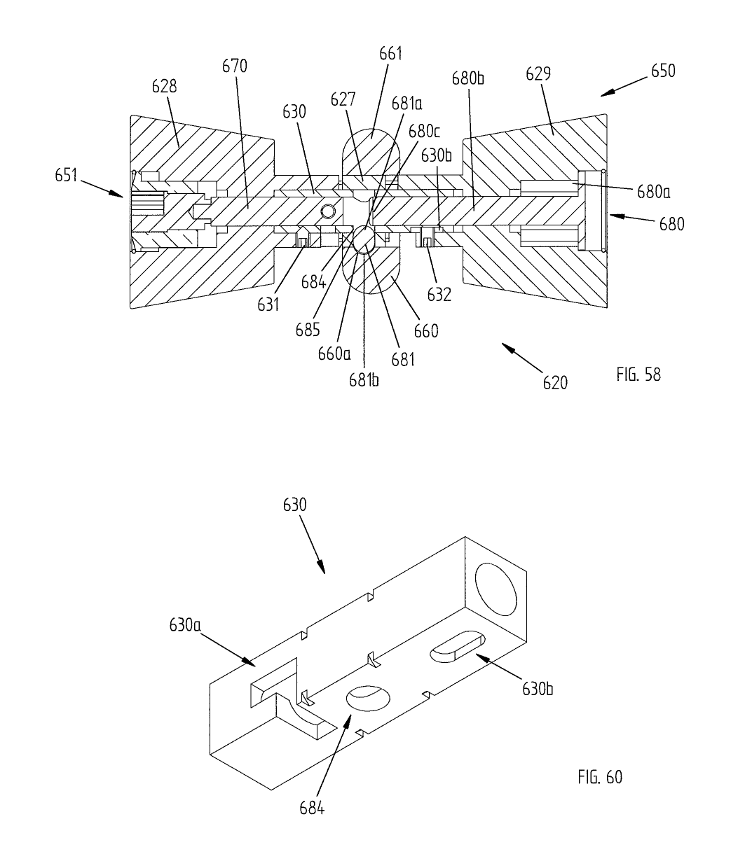

This release operation is performed by pulling the right knob 629, as shown in FIG. 58, in a direction away from the panel 200, that is, rightwards in the figure. The right knob 629, in fact, from the locking position shown in FIG. 57 can slide to the right thanks to the dowel 632 that slides inside the slit 630b provided in the interconnection element 630.

During the movement of the right knob 629 with respect to the interconnection element 630, the end portion 680a of the button 680 is pushed and thus its end 680c releases the locking element 681 that is thus free to move.

The initial conditions of the system are thus restored.

Figures from 61 to 63 show a variant embodiment of the system according to the invention.

This variant embodiment differs from the embodiment described above with reference to Figures from 1 to 5 due to the different construction structure of the handle 127′ and the different configuration of the locking system that serves for the engagement of the first component 10 with the second component 720.

This locking system is such that the second end portion 12 of the first component 10 is suited to be housed in the second component 720 where two helical springs 23a and 23b, instead of one, and two corresponding rotatable and translatable elements 24a and 24b are accommodated.

Differently from that which happens in the embodiments previously described, here the end portion 12 of the first component 10 cooperates with two rotatable and translatable elements 24a and 24b instead of with one element only. The locking action of the end portion 12 into the second component 720, however, is analogous to that described above, in which the friction of the rotatable elements 24a and 24b is exploited. The rotatable and translatable elements 24a and 24b, preferably balls, are located at the level of the free end of the corresponding helical spring 23a and 23b, so that each helical spring 23a, 23b exerts a thrusting action on the corresponding rotatable element 24a, 24b, analogously to that which has been observed in the case where one ball only is used.

In variant embodiments of the invention the rotatable and translatable elements can be of a different type, like for example a small cylinder or rod iron.

The second component 720 is advantageously associated with releasing means 750.

The releasing means 750 comprise a handle 127′ preferably constituted by two shaped levers 127′a, 127′b. Each lever 127′a, 127′b comprises a first portion 140′a, 140′b suited to be placed in contact with the rotatable elements 24a, 24b and a centre portion 141′a, 141′b suited to be accessed by a user.

The shaped levers 127′a, 127′b, in particular, are suited to be translated towards the inside of the component 720 through the action exerted by the user on the corresponding centre portion 141′a, 141′b, and then through the traction exerted by the user on the centre portion 141′a, 141′b from left to right, as shown in FIG. 61C. Each shaped lever 127′a, 127′b is maintained in its inoperative position in the direction contrary to the direction of traction, and therefore from right to left in the figures, through the action of an elastic return spring 135a that preferably acts on a lower end 142′a, 142′b of the corresponding lever 127′a and 127′b.

In variant embodiments of the invention, the return thrusting means can be made in a different manner, for example with suitable magnetic and/or electromagnetic means.

During the translation of one of the two shaped levers 127′a, 127′b towards the inside of the second component 720, the rotatable elements 24a, 24b are pushed inside the component 720 against the action of the springs 23a, 23b, thus pushing them towards the release position, analogously to that which has been described above regarding the use of one ball only.

In the release position shown in FIG. 61C, the end 12 of the first component 10 will be free to translate and therefore can be moved completely out of the second component 720 (thus obtaining the mutual release of the two components 720 and 10 of the system and also the opening of the associated panel 200).

In order to allow the second end portion 12 of the first component 10 to be inserted in the second component 720, the two shaped levers 127′a, 127′b have respective recessed areas 143′a, 143′b suited to define a slit 145 that accommodates said second end portion 12, as shown in FIG. 63.

Some embodiments of the first component of a system according to the present invention are described below with reference to Figures from 64 to 81.

In the various embodiments described above, the first component is substantially constituted by a bar-shaped element (for example in metal, plastic or another similar rigid material) and is suited to be rigidly fixed to a wall portion, for example the post of a door or window.

In particular, an end portion, indicated above as second end portion 12 of the first component 10, projects from said wall portion. Said end portion 12 of the first component 10 can however be bulky and/or dangerous.

The embodiments described below, therefore, refer to some solutions for the construction of the first component of the system according to the invention that are suited to overcome said drawback.

The solutions described herein make reference to a system in which the second component 420 is of the type described above with reference to Figures from 24 to 36. It is evident that the solutions described below can be applied to any type of system illustrated above or falling within the inventive concept expressed by the present invention.

The Figures from 64 to 69 show a first embodiment of the first component 10′. The first component 10′ comprises the end portion 12′ suited to be housed in the second component 420, according to the description provided above with reference to Figures from 24 to 36. The end portion 12′ projects with respect to the wall portion 100. According to the present embodiment, the end portion 12′ of the first component 10′ is associated with a retractable covering element 901. In the rest condition, that is, when the door is open and the first component 10′ is not engaged with the second component 420, as shown in FIGS. 65 and 67, the covering element 901 entirely covers the end portion 12′. The covering element 901 preferably and advantageously has a rounded shape, without corners, in such a way as to avoid any injury to people even in case of accidental contact (which may be a risk if the end portion 12′ were not covered). Furthermore, the covering element 901 is preferably made of a soft material, for example soft plastic.

The front portion of the covering element 901 is provided with an opening 905 for the passage of the end portion 12′.

The covering element 901, furthermore, is preferably associated with thrusting means 902 suited to maintain the covering element 901 in said rest condition. The thrusting means 902 preferably comprise two helical springs 902a, 902b that maintain the covering element 901 in an external position with respect to the wall portion 100.

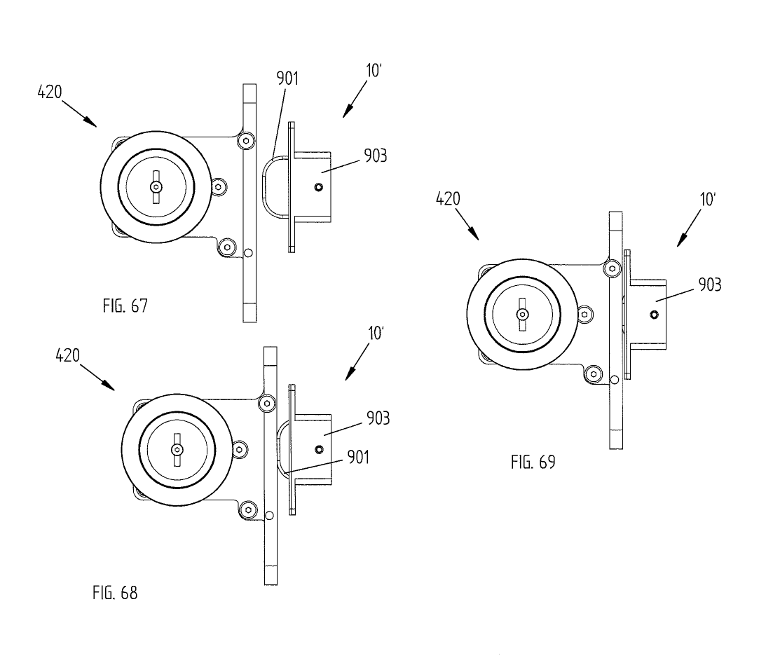

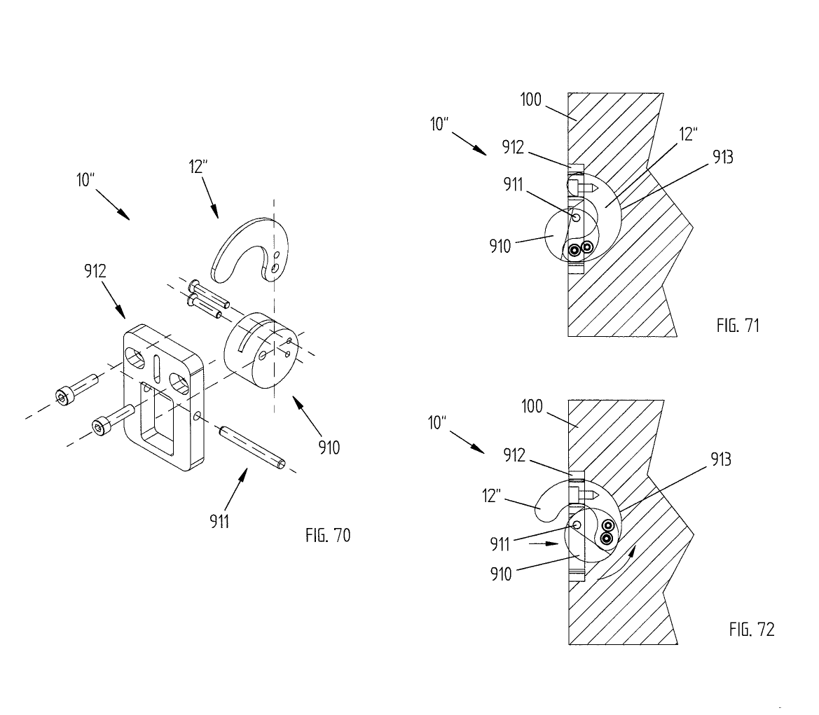

The helical springs 902a, 902b are housed in a seat 903 suited to accommodate the covering element 901 when the latter is pushed towards the wall portion 100, as shown in FIGS. 66, 68 and 69.

The seat 903 that accommodates the covering element 901 is advantageously positioned inside the wall portion 100.

When the second component 420 is pushed towards the first component 10′, that is, while the door is being closed, the covering element 901 is moved back into said seat 903, as shown in FIGS. 66, 68 and 69, while the end portion 12′ moves out of the opening 905, remaining exposed. The end portion 12′ is thus locked to the second component 420, according to the procedures extensively explained above. When, vice versa, the door is opened and the second component 420 is disengaged from the first component 10′, the covering element 901 is automatically brought to the rest condition, in which it protects the end portion 12′, thanks to the action of the helical springs 902a, 902b.

It is evident that in variant embodiments of the invention the number and shape of the thrusting means, as well as the shape of the covering element, can be different from those indicated above.

Figures from 70 to 75 show a second embodiment of the first component 10″.

The first component 10″ comprises the end portion 12″ suited to be accommodated in the second component 420, according to the description provided above with reference to Figures from 24 to 36.

The end portion 12″ is preferably arc-shaped, and more preferably semi-circular. In the rest condition, that is, when the door is open and the first component 10″ is not engaged with the second component 420, as shown in FIGS. 71 and 73, the end portion 12″ does not project from the wall portion 100. In this rest condition, the end portion 12″ is accommodated in a seat 913 preferably created directly in the wall portion 100.

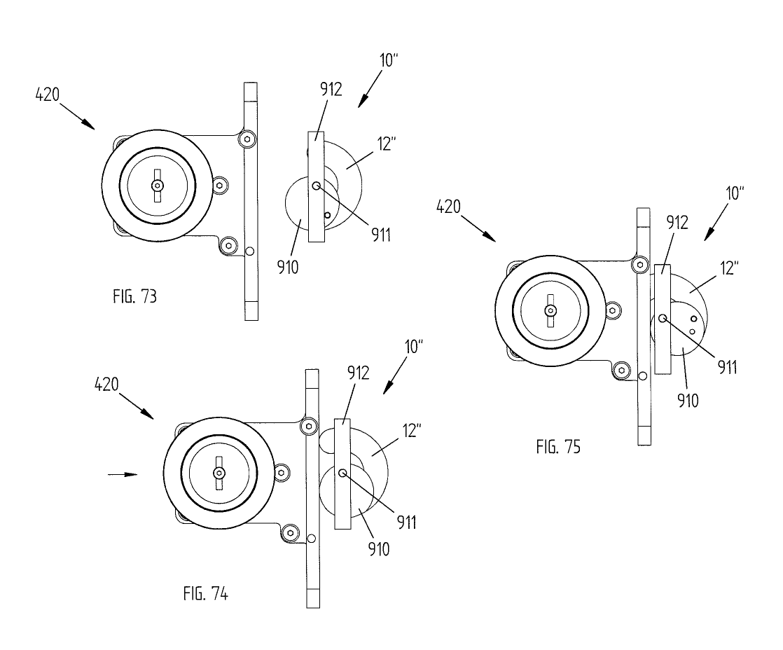

According to the present embodiment, the end portion 12″ is made project automatically with respect to the wall portion 100 when the second component 420 is pushed towards the first component 10″, that is, while the door is being closed, as shown in FIGS. 72, 74 and 75.

For this purpose, the end portion 12″ is hinged on a thrusting element 910.

The thrusting element 910 is in turn hinged, around a rotation pin 911, to an element 912 suited to be fixed to the wall portion 100. In the rest condition, that is, when the door is open and the first component 10″ is not engaged with the second component 420, as shown in FIGS. 71 and 73, the thrusting element 910 is partially housed in the seat 913 and projects at least partially with respect to the wall portion 100.

The thrusting element 910 preferably and advantageously has a rounded shape, without corners, in such a way as to avoid any injury to people even in case of accidental contact. Furthermore, preferably, the thrusting element 910 is made of a soft material, for example soft plastic.

The thrusting element 910 and the end portion 12″ are normally in said rest condition (the one shown in FIG. 71) due to the force of gravity related to their weight force.

In variant embodiments of the invention, however, the thrusting element 910 is preferably associated with thrusting means that are suited to maintain the thrusting element 910 and the end portion 12″ in said rest condition. The thrusting means comprise, for example, a spring that maintains the thrusting element 910 in the rest condition. It is evident that said thrusting means can be of a different type.

In the rest position, advantageously, the end portion 12″ does not project from the wall portion 100, and therefore does not represent an encumbrance.

When the second component 420 is pushed towards the first component 10″, that is, while the door is being closed, the second component 420 acts pushing the projecting portion of the thrusting element 910, as shown in FIGS. 74 and 75. This thrusting action causes the thrusting element 910 to rotate around the rotation pin 911 and consequently the end portion 12″ to move out of the wall portion 100. The end portion 12″ is thus received in and locked to the second component 420, according to the procedures extensively described above. When, vice versa, the door is opened by disengaging the second component 420 from the first component 10″, the end portion 12″ and the thrusting element 910 are automatically brought to the rest condition due to the force of gravity related to their weight force (or to the effect of special thrusting means, if provided, as described above).

It is evident that in variant embodiments of the invention the shape of the thrusting element can be different from the one described herein.

Figures from 76 to 81 show a third embodiment of the first component 10′″. The first component 10′″ comprises the end portion 12′″ suited to be accommodated in the second component 420, according to the description provided above with reference to Figures from 24 to 36.

In the rest condition, that is, when the door is open and the first component 10′″ is not engaged with the second component 420, as shown in FIGS. 77 and 79, the end portion 12′ does not project with respect to the wall portion 100. In this rest condition the end portion 12′″ is accommodated in a seat 923 preferably created directly in the wall portion 100.

In the rest condition, advantageously, the end portion 12′″ does not project from the wall portion 100, and therefore does not represent an encumbrance.

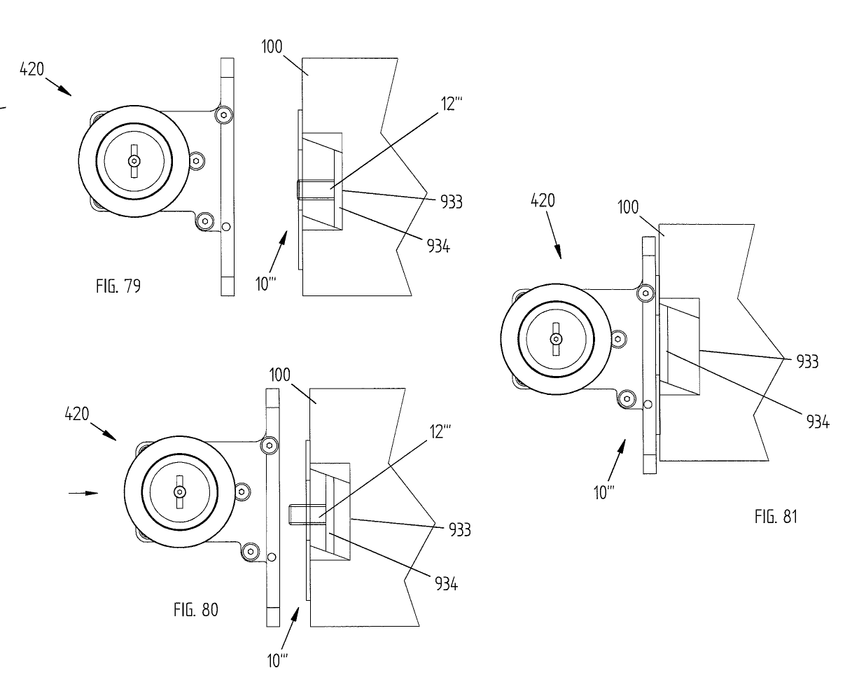

According to the present embodiment, the end portion 12′″ is made project automatically with respect to the wall portion 100 through magnetic attraction when the second component 420 approaches the first component 10″, that is, while the door is being closed, as shown in FIGS. 78, 80 and 81.

For this purpose, at least one part of the end portion 12′″ and/or at least one part of the second component 420 comprise/s materials suited to be attracted magnetically when moved near each other.

For example, in a first embodiment, the end portion 12′″ may comprise a magnetic material and a part of the second component 420 may comprise a ferrous material, or vice versa. In other cases, both the end portion 12′″ and at least one part of the second component 420 may comprise a properly polarized magnetic material, so that they are mutually attracted when moved near each other.

It is evident that in further embodiments of the invention there may be any other combination between magnetic and ferromagnetic materials to be associated with the first and the second component of the system.

In the embodiment described herein, in the rest condition, that is, when the door is open and the first component 10′″ is not engaged with the second component 420, as shown in FIGS. 77 and 79, the end portion 12′″ is accommodated in a seat 933. The seat 933 that accommodates the end portion 12′″ is advantageously positioned inside the wall portion 100.

The end portion 12′″ also comprises a supporting base 934.

The end portion 12′″ is associated with a guide element 935 suited to be fixed to the wall 100. The guide element 935 comprises an opening 936 for the passage of the end portion 12′″ and two oblique walls 937a, 937b that serve as a guide for the base 934 of the end portion 12′″.

The end portion 12′″ with the supporting base 934 are normally in said rest condition (that shown in FIG. 77) due to the force of gravity related to their weight force.

In variant embodiments, however, the end portion 12′″ with the supporting base 934 are preferably associated with thrusting means suited to maintain the end portion 12′″ with the base portion 934 in said rest condition. The thrusting means comprise, for example, a spring that maintains the end portion 12′″ with the supporting base 934 in the rest position. It is evident that said thrusting means can be of a different type.

In other variant embodiments, the thrusting means can be made in a different manner, for example with magnetic elements suited to maintain the end portion 12′″ in the seat 933 in which the attraction force of said magnetic elements is lower than the magnetic attraction force between the end portion 12′″ and the second component 420.

When the second component 420 is pushed towards the first component 10′″, that is, while the door is being closed, the magnetic attraction force acts between the second component 420 and the end portion 12′″, and the end portion 12′″ moves out of the opening 936 and therefore of the wall portion 100. The end portion 12′″ is thus housed in and locked to the second component 420, according to the procedures extensively described above. When, instead, the door is opened disengaging the second component 420 and moving it away from the first component 10′″, there is no more magnetic force and the end portion 12′″ with the supporting base 934 is automatically moved back due to the force of gravity related to their weight force (or due to the action of apposite thrusting means, if provided, as described above).

Although the invention has been described making reference to the attached drawings, in the construction stage it can be subjected to changes that are all to be considered protected by the present patent, provided that they fall within the same inventive concept expressed in the following claims.

In variant embodiments of the invention, for example, the elastic element (or spring) that thrusts the translatable element may be replaced by a magnet. The magnet may comprise, in particular, two portions having the same polarity (positive or negative), of which a first portion is integral with the translatable element, while a second portion is integral with the second component. The magnetic force generated between the two portions will tend to push the portion of the magnet that is integral with the translatable element towards the outside of the component, and thus the translatable element itself in the same direction towards the outside of the component. In this embodiment, furthermore, the releasing means will push against the rotatable and translatable element, wherein said thrusting action will be exerted against the action of the magnetic force instead of against the action of an elastic element as in the embodiments previously described.

Furthermore, other embodiments of the invention may include suitable combinations of the solutions described above with reference to the various embodiments. In this way, for example, a sliding door or a single door can be provided with a system comprising on one side a handle of the lever type and on the other side a handle of the knob type, so that the operation of said handles can be obtained by thrust or traction or rotation or combined rotating and translating movements. Again, the system can be provided with one or more of the locking systems illustrated above, like for example a manual locking device or a key locking device on both sides of the system, emergency release devices on both sides of the system, etc.

It has thus been shown by means of the above description that the system according to the present invention allows all the set objects to be achieved.

Although the present invention has been illustrated above by means of the detailed description of some of its embodiments illustrated in the drawings, the present invention is not limited to the embodiments described above and represented in the drawings; on the contrary, further variants of the embodiments described herein fall within the scope of the present invention, which is defined in the claims.

1. A quick connection and/or fixing system suited to mutually connect and disconnect a door/window panel (200) to/from a portion of a wall (100), said panel (200) being suited to close an opening (A) giving access to a room at least partially defined by said wall (100), said system comprising a first and a second component (10, 20) suited to be rigidly fixed respectively to said wall portion (100) and to said panel (200), said first and said second component (10, 20) being furthermore suited to be mutually connected and disconnected so as to alternatively allow the mutual connection and disconnection of said panel (200) and said wall portion (100), wherein said second component (20) is suited to accommodate an end portion (12) of said first component (10), in such a way as to allow its translation inside it, said second component (20) also comprising counteracting device suited to counteract the translation of said end portion (12) of said first component (10) towards the outside of said second component (20), said system also comprising at least one rotatable element (24) housed inside said second component (20) and suited to be set rotating according to a first direction of rotation by the translation of the end portion (12) of the first component (10) towards the inside of the second component (20), and suited to be set rotating in a second direction of rotation contrary to the first direction of rotation by the translation of the end portion (12) of the first component (10) towards the outside of the second component (20), said counteracting device being suited to counteract the rotation of said at least one rotatable element (24) in said second direction of rotation, said second component (20) comprising releasing device (27) suited to be translated and to come into contact, during their motion according to a first pre-determined direction, with said at least one rotatable element (24), in such a way as to move said at least one rotatable element (24) so as to cause a decrease in the counteracting force between said at least one rotatable element (24), said end portion (12) and said counteracting device, wherein said releasing device (27) comprise two second component and the other handle being positioned on the opposite side with respect to said first side of said second component so that they can be operated by said user from corresponding opposite sides of said door/window panel (200) when said second component is fixed to said panel (200), and in that each of said two handles can be operated along a direction that is substantially parallel to said first pre-determined direction.

2. The system according to claim 1, wherein said second component comprises second thrusting device (20) that exert a thrusting action against said releasing device in a second direction contrary to said first direction of motion of said releasing device.

3. The system according to claim 1, wherein said second component comprises safety locking device suited to inhibit the movement of at least one of said two handles.

4. The system according to claim 3, wherein said safety locking device can be operated from a first side of said second component and are suited to inhibit the movement of the handle positioned on the opposite side with respect to said first side of said second component or said safety locking device are suited to inhibit the movement of both of said two handles.

5. The system according to claim 3, wherein said safety locking device can be operated both from a first side of said second component and from the opposite side with respect to said first side of said second component.

6. The system according to claim 3, wherein said safety locking device comprise a locking element suited to be operated manually by said user.

7. The system according to claim 6, wherein said locking element comprises a lever suited to be rotated through a portion around a rotation axis, in such a way that it comes to be arranged in at least one operative locking position of said at least one handle and in at least one inoperative position not interfering with said at least one handle.

8. The system according to claim 3, wherein said safety locking device comprise a locking element suited to be operated by said user through a key.

9. The system according to claim 3, wherein it comprises emergency releasing device suited to be operated in order to release said safety locking device and restore the possibility to move said at least one handle.

10. The system according to claim 1, wherein said system comprises also two rotatable elements (24a, 24b) housed inside said second component (20) and suited to be set rotating in a first direction of rotation by the translation of the end portion (12) of the first component (10) towards the inside of the second component (720), and suited to be set rotating in a second direction of rotation contrary to the first direction of rotation by the translation of the end portion (12) of the first component (10) towards the outside of the second component (720), said counteracting device being suited to counteract the rotation of said two rotatable elements (24a, 24b) in said second direction of rotation, said second component (720) comprising releasing device suited to be translated and to come into contact, during their motion in a first pre-determined direction, with said two rotatable elements (24a, 24b) so as to move said two rotatable elements (24a, 24b) and to generate a decrease in the counteracting force between said two rotatable elements (24a, 24b), said end portion (12) and said counteracting device.

11. The system according to claim 10, wherein said two rotatable elements (24a, 24b) are accommodated inside said second component (720) in a position in which they face each other.

12. A door or window panel (200) comprising a component of a quick connection and/or fixing system suited to mutually connect and disconnect said panel (200) to/from a portion of a wall (100), wherein said component is constituted by the second component of the connection and/or fixing system according to claim 1.
